(19) United States
(12) Patent Application Publication
(10) Pub. No.: US 2002/0032262 A1
(43) Pub. Date: Mar. 14, 2002

(54) 2-aminoarylmethylamine solid support templated for preparation of highly functionalized heterocycle compounds

(76) Inventors: Jinfang Zhang, Louisville, KY (US); Boliang Lou, Louisville, KY (US)

Correspondence Address: John E. Vanderburgh, 608 Sunset Road, Louisville, KY, 40206, US

(21) Appl. No.: 09/841,161

(22) Filed: Apr. 24, 2001

Related U.S. Application Data
(60) Provisional application No. 60/199,266, filed on Apr. 24, 2000.

(51) Int. Cl. C08J 7/12

(52) U.S. Cl. 524/375; 525/374

(57) ABSTRACT

A solid support template for the preparation of highly functionalized heterocycle compounds of the formula;

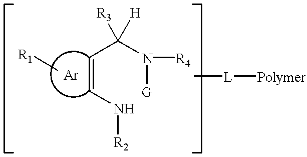

### CROSS REFERENCE TO RELATED APPLICATIONS

This application claims the benefit under 35 U.S.C. 119(e) of United States provisional application _{60/199,266}, filed Apr. 24, 2000 entitled 2-AMINOARYLMETHYLAMINE SOLID SUPPORT TEMPLATE FOR PREPARATION OF HIGHLY FUNCTIONALIZED HETEROCYCLE COMPOUNDS.

### FIELD OF INVENTION

The present invention relates to a novel solid support template of Formula 1 and methods for producing novel highly functionalized dihydroquinazoline-, quinazoline- and benzodiazepinone-type of heterocyclic scaffolds through a plurality of chemical reactions utilizing the solid support template.

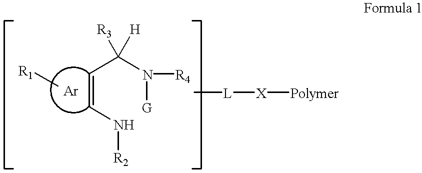

### BACKGROUND OF INVENTION

Heterocyclic compounds occupy a very important position in the arsenal of clinically useful therapeutic agents. Because of the beneficial medicinal effects of members of this vast class of compounds, interest remains strong for the synthesis of novel heterocyclic compounds and known heterocyclic ring systems where there is ample novel chemistry left to explore.

Advances in molecular biology and application of automated techniques in biological screening allow the testing of a large number of compounds to be carried out rapidly and efficiently. The field of combinatorial chemistry has arisen largely out of the need to synthesize larger numbers of diverse compounds more rapidly than conventional organic synthesis techniques permit, to keep pace with high throughput biological screening capabilities. The present invention introduces a novel method based a solid support template for the efficient preparation of a wide range of novel and highly substituted heterocycles in large numbers.

Chemical synthesis of heterocyclic organic molecules on solid phase support has received considerable attention in recent years (Corbett, J. W., Org. Prep. Proc. Int., 1998, 30, 489; Nefzi, A., Ostresh, J. M., Houghten, R. A., 1997, 97, 449; Hermkens, P. H. H., Ottenheijm, H. C. J. and Rees, D. C., Tetrahedron 1997, 53, 5643-5678; Balkenhohl, F., von dem Bussche-Hunnefeld, C., Lansky, A. and Zechel, C., Angew. Chem. Int. Ed. Engl. 1996, 35, 2288-2337; Hermkens, P. H. H., Ottenheijm, H. C. J. and Rees, D. C., Tetrahedron 1996, 52, 4527-4554).

In most solid phase syntheses of heterocyclic compounds a single heterocyclic scaffold is produced where substitution from appropriate positions on the heterocycle permits numerous analogues to be made that all possess the same heterocyclic scaffold. In order to prepare a different heterocyclic scaffold, as well as the substituents on the scaffold, requires that a new synthetic approach must be used. This oftentimes requires significant effort and time to optimize the synthetic procedure by which novel heterocyclic compounds can be prepared.

Recently published work (by Keating, T. A. and Armstrong, R. W., J. Am. Chem. Soc. 1996, 118, 2574-2583) has demonstrated the synthesis of several heterocyclic & acyclic compounds from a common cyclohexenamide Ugi reaction product in solution phase (see scheme A). Chemical modification of the cyclohexenamide under acidic conditions leads to a munchnone intermediate (see scheme A) which reacts with a number of nucleophiles (alcohols and mercaptans), inter- or intramolecularly, and also dipolarophiles (disubstituted acetylenes) to form the products shown in scheme A. The synthetic strategy using the

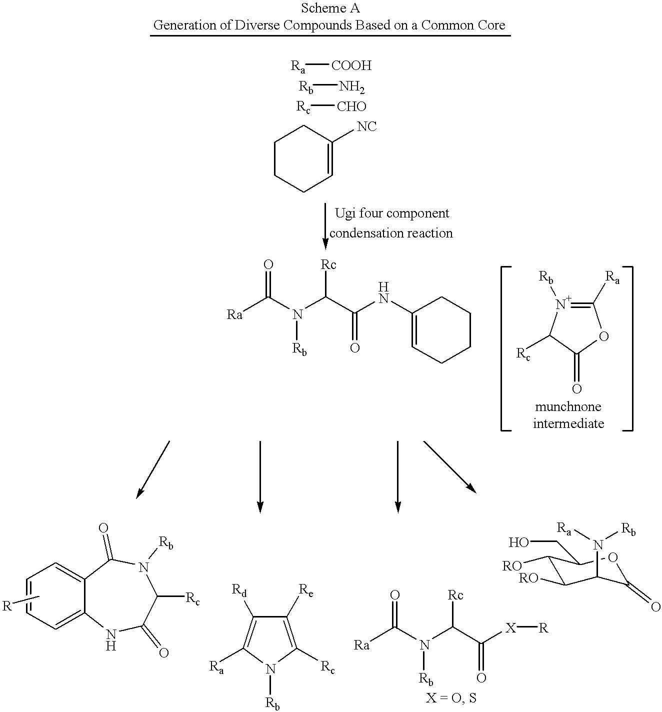

Ugi cyclohexenamide allows not only the generation of analogues of the same scaffold but also the synthesis of novel scaffolds, eg. 1,4-benzodiazepinone, pyrrole, 2-acetamido-2-deoxy-D-manno-δ-lactone and several acyclic modified Ugi products.

There is a need in the field of combinatorial chemistry for highly efficient synthetic methods like the example in scheme A for accessing a wide range of compounds that possess structural diversity in the scaffold, as well as, large numbers of analogues of single scaffolds. The synthetic method in the present invention allows the synthesis of large numbers of heterocyclic compounds on solid support where not only the side chains can be easily varied but also many unique heterocyclic scaffolds are synthesized from the same building block.

The present invention relates to a novel solid support template and its use for preparing many novel heterocyclic scaffolds and analogues thereof.

### SUMMARY OF INVENTION

The present invention relates to a solid support template of Formula 1, wherein

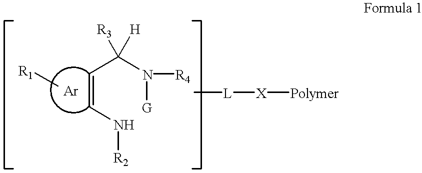

Polymer is the solid support, and include the following:

a.) beads, pellets, disks, fibers, gels, or particles such as cellulose beads, pre-glass beads, silica gels, polypropylene beads, polyacrylamide beads, polystyrene beads that are lightly cross-linked with 1-2% divinylbenzene and optionally grafted with polyethylene glycol and optionally functionalized with amino, hydroxy, carboxy or halo groups; and

b.) soluble supports such as low molecular weight non-cross-linked polystyrene and polyethylene glycol.

The term solid support is used interchangeably with the term resin or bead in this invention and is intended to mean the same thing.

X is a covalent bond, an atom or a functional group connecting the polymer and the linker L, including but not limited to oxygen, ester, amide, sulfur, silicon and carbon;

L is a suitable multifunctional chemical monomer in which one functional group reacts with the polymer to form a covalent bond and the other functional group reacts with either R₁, R₃, R₄ or G through a plurality of chemical reactions to provide the desired templates for further chemistry. Examples of such monomers include a-amino acids, β-amino acids, 4-aminopiperidine, 3- or 4-hydroxyaniline, piperazine. The hydroxymethyl polystyrene resin, the Wang resin and the Rink resin are examples of solid phase supports used in the preparation of compounds of this invention. Other known or commercially available solid phase supports work in this method and are considered to lie within the scope of this invention.

The following structure presents an aryl-ring or a heteroaryl-ring system substituted by one or more R₁ groups:

[chemical structure]

The following symbol means one of the groups, including R₁, R₃,

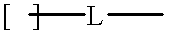

R4, G, must be attached to the solid support through the linker L, it is selected from a group consisting of a covalent bond or a multifunctional chemical monomer possessing at least two attachment points which link the template backbone and the linker L. or

R₁ is selected from a group consisting of hydrogen, chloro, fluoro, bromo, iodo, nitro, cyano, substituted alkyl, substituted alkenyl, substituted alkynyl, substituted aryl, substituted heteroaryl, substituted cycloalkyl and substituted alkylcycloalkyl; substututed heterocyclyl; or

R₁ is selected from a group consisting of amino, substituted amino, hydroxyl, substituted hydroxyl, substituted sulfhydryl, substituted alkyl sulfonamido, substituted alkyl carboxamido, substituted alkyl ureido, substituted alkyl sulfamido, substituted alkyloxycarboxamido, substituted aryl sulfonamido, substituted aryl carboxamido, substituted aryl ureido, and substituted alkyloxycarboxamido;

R₂ is selected from a group consisting of hydrogen, hydroxy, substituted alkyl, substituted alkenyl, substituted alkynyl, substituted aryl, substituted heteroaryl, substituted cycloalkyl and substituted heterocyclyl;

R₃ is hydrogen, —C(O)NHR₅, substituted alkyl, substituted alkenyl, substituted alkynyl, substituted aryl, substituted heteroaryl, substituted cycloalkyl; substituted heterocyclyl;

G is selected from a group consisting of hydrogen, substituted alkylcarbonyl, substituted arylcarbonyl, substituted arylalkylcarbonyl, substituted alkyloxycarbonyl, substituted N-alkylaminocarbonyl, substituted NAN-dialkylaminocarbonyl, substituted N-arylaminocarbonyl, substituted N,N-diarylaminocarbonyl, substituted N-alkyl-N-arylaminocarbonyl, alkylthiocarbonyl, substituted arylthiocarbonyl, substituted arylalkylthiocarbonyl, substituted N-alkylaminothiocarbonyl, substituted N,N-dialkylaminothiocarbonyl, substituted N-arylaminothiocarbonyl, substituted N,N-diarylaminothiocarbonyl, substituted N-alkyl-N-arylaminothiocarbonyl, substituted alkylsulfonyl, substituted arylsulfonyl;

R₄ and R₅ are independently selected from a group consisting of hydrogen, substituted alkyl, substituted alkenyl, substituted alkynyl, substituted aryl, substituted heteroaryl, substituted cycloalkyl and substituted heterocyclyl;

### DETAIL DESCRIPTION OF THE INVENTION

As used above, and through the description of the invention, the following terms, unless otherwise indicated, shall be understood to have the following meanings:

Definitions

As used herein, the “—” (e.g. —C(O)NHR₅ which indicates the carbonyl attachment point to the scaffold) signifies a stable covalent bond, certain preferred points of attachment points being apparent to those skilled in the art.

The term “halogen” or “halo” include fluorine, chlorine, bromine, and iodine.

“Alkyl” means a saturated aliphatic hydrocarbon group which may be straight or branched and having about 1 to about 20 carbons in the chain. Branched means that a lower alkyl group such as methyl, ethyl, or propyl is attached to a linear alkyl chain. Preferred straight or branched alkyl groups are the “lower alkyl” groups which are those alkyl groups having from 1 to about ₆ carbon atoms.

“Alkenyl” means an aliphatic hydrocarbon group defined the same as for “alkyl” plus at least one double bond between two carbon atoms anywhere in the hydrocarbon.

“Alkynyl” means an aliphatic hydrocarbon group defined the same as for “alkyl” plus at least one triple bond between two carbon atoms anywhere in the hydrocarbon.

“Aryl” represents an unsubstituted, mono-, di- or trisubstituted monocyclic, polycyclic, biaryl aromatic groups covalently attached at any ring position capable of forming a stable covalent bond, certain preferred points of attachment being apparent to those skilled in the art. Aryl thus contains at least one ring having at least 5 atoms, with up to two such rings being present, containing up to 10 atoms therein, with alternating (resonating) double bonds between adjacent carbon atoms. Aryl groups may likewise be substituted with 0-3 groups selected from Rr. The definition of aryl includes but is not limited to phenyl, biphenyl, indenyl, fluorenyl, naphthyl (1-naphtyl, 2-naphthyl).

Heteroaryl is a group containing from 5 to 10 atoms, 1-4 of which are heteroatoms, 0-4 of which heteroatoms are nitrogen, and 0-1 of which are oxygen or sulfur, said heteroaryl groups being substituted with 0-3 groups selected from R₈. The definition of heteroaryl includes but is not limited to pyridyl, furyl, thiophenyl, indolyl, thiazolyl, imidazolyl, benzimidazolyl, tetrazolyl, pyrazinyl, pyrimidyl, quinolyl, isoquinolyl, benzofuryl, isothiazolyl, benzothienyl, pyrazolyl, isoindolyl, isoindolyl, purinyl, carbazolyl, oxazolyl, benzthiazolyl, benzoxazolyl, quinoxalinyl, quinazolinyl, and indazolyl.

“Cycloalkyl” means a saturated carbocyclic group having one or more rings and having 3 to about 10 carbon atoms. Preferrd cycloalkyl groups include cyclopropyl, cyclobutyl, cyclopentyl, cyclohexyl, cycloheptyl, and decahydronaphthyl.

“heterocyclyl” means an about 4 to about 10 member monocyclic or multicyclic ring system wherein one or more of the atoms in the ring system is an element other than carbon chosen amongst nitrogen, oxygen or sulfur. The heterocyclyl may be optionally substituted by one or more alkyl group substituents. Examplary heterocyclyl moieties include quinuclidine, pentamethylenesulfide, tetrahedropyranyl, tetrahydrothiophenyl, pyrrolidinyl or tetrahydrofuranyl.

“Saturated” means that the atom possesses the maximum number of single bonds either to hydrogen or to other atoms, eg. a carbon atom is sp³ hybridized.

“Unsaturated” means that the atom possesses less than the maximum number of single bonds either to hydrogen or to other atoms, eg. a carbon atom is sp² or sp³ hybridized.

“Substituted” means the attachment of any of the following groups, including:

(i) H

(ii) alkyl

(iii) aryl

(iv) amino, amidino, bromo, chloro, carboxy, carboxamido, thiocarboxy, cyano, fluoro, guanidino, hydroxy, iodo, nitro, oxo, thiol, trihalomethyl, trihalomethoxy

(v) N-(C₁-C₆alkyl)amidino and N-aryl amidino

(vi) N-(C₁-C₆alkyl)guanidino and N-aryl guanidino

(vii) C₁-C₆alkylamino and arylamino

(viii) N,N′-(C₁-C₆dialkyl)amino, N,N′-diarylamino and N-(C₁-C₆alkyl)-N′-(aryl)-amino

(ix) C₁-C₆alkylarylamino and aryl C₁-C₆alkylamino

(x) 4-, 5-, ₆-, or 7- membered azacycloalkanes

(xi) C₁-C₆alkyloxy and aryloxy

(xii) C₁-C₆alkylaryloxy and arylC₁-C₆alkyloxy

(xiii) C₁-C₆alkylarylthio and arylC₁-C₆alkylthio

(xiv) C₁-C₆alkylcarbonyl and arylcarbonyl

(xv) C₁-C₆alkylarylcarbonyl and arylC₁-C₆alkylcarbonyl

(xvi) C₁-C₆alkoxycarbonyl and aryloxycarbonyl

(xvii) C₁-C₆alkylaryloxycarbonyl and arylC₁-C₆alkyloxycarbonyl

(xviii) C₁-C₆alkylarylthiocarbonyl and arylC₁-C₆alkylthiocarbonyl

(xix) N-mono-(C₁-C₆alkyl) and N,N′-di-(C₁-C₆alkyl)aminocarbonyl

(xx) N-mono-(aryl) and N,N′-di-(aryl)aminocarbonyl

(xxi) N,N′-(C₁-C₆alkyl) (aryl) aminocarbonyl

(xxii) N-mono-(C₁-C₆alkylaryl) and N,N′-di-(arylC₁-C₆alkyl)aminocarbonyl

(xxiii) N,N′-(C₁-C₆alkyl)(arylC₁-C₆alkyl)aminocarbonyl

(xxiv) N,N′-(aryl) (arylC₁-C₆alkyl)aminocarbonyl

(xxv) C₁-C₆alkylcarbonylamino and arylcarbonylamino

(xxvi) C₁-C₆alkylarylcarbonylamino and arylC₁-C₆alkylcarbonylamino

(xxvii) C₁-C₆alkoxycarbonylamino and aryloxycarbonylamino

(xxviii) C₁-C₆alkylaryloxycarbonylamino and arylC₁-C₆alkyloxycarbonylamino

(xxvii) C₁-C₆alkylarylthiocarbonylamino and arylC₁-C₆alkylthiocarbonylamino

(xxx) N-mono-(C₁-C₆alkyl) and N,N′di-(C₁-C₆alkyl)aminocarbonylamino

(xxxi) N-mono-(aryl) and N,N′-di-(aryl)aminocarbonylamino

(xxxii) N,N′(C₁-C₆alkyl) (aryl)aminocarbonylamino

(xxxiii) N-mono-(C₁-C₆alkylaryl) and N,N′-di-(arylC₁-C₆alkyl) aminocarbonylamino

xxxiv) N,N′-(C₁-C₆alkyl)(arylC₁-C₆alkyl)aminocarbonylamino

(xxxv) N,N′-(aryl) (arylC₁-C₆alkyl)aminocarbonylamino

(xxxvi) C₁-C₆alkylcarbonyloxy and arylcarbonyloxy

(xxxvii) C₁-C₆alkylarylcarbonyloxy and arylC₁-C₆alkylcarbonyloxy

(xxxviii) C₁-C₆alkoxycarbonyloxy and aryloxycarbonyloxy

(xxxix) C₁-C₆alkylaryloxycarbonyloxy and arylC₁-C₆alkyloxycarbonyloxy

(xl) C₁-C₆alkylarylthiocarbonyloxy and arylC₁-C₆alkylthiocarbonyloxy

(xli) N-mono-(C₁-C₆alkyl) and N,N′-di-(C₁-C₆alkyl)aminocarbonyloxy

(xlii) N-mono-(aryl) and N,N′-di-(aryl)aminocarbonyloxy

(xliii) N,N′-(C₁-C₆alkyl)(aryl)aminocarbonyloxy

(xliv) N-mono-(C₁-C₆alkylaryl) and N,N′-di-(arylC₁-C₆alkyl) aminocarbonyloxy

xlv) N,N′-(C₁-C₆alkyl) (arylC₁-C₆alkyl)aminocarbonyloxy and N,N′-(aryl) (arylC₁-C₆alkyl) aminocarbonyloxy

(xlvi) C₁-C₆alkylsulfoxy and arylsulfoxy

(xlvii) C₁-C₆alkylarylsulfoxy and arylC₁-C₆alkylsulfoxy

(xlviii) C₁-C₆alkylsulfonyl and aryl sulfonyl

(xlix) C₁-C₆alkylarylsulfonyl and arylC₁-C₆alkylsulfonyl

(l) C₁-C₆alkylsulfonamido and arylsulfonamido

(li) C₁-C₆alkylarylsulfonamido and arylC₁-C₆alkylsulfonamido

(lii) C₁-C₆alkylaminosulfonyl and arylaminosulfonyl

(liii) C₁-C₆alkylarylaminosulfonyl and arylC₁-C₆alkylaminosulfonyl

(liv) C₁-C₆alkylaminosulfonamido and arylaminosulfonamido

(lv) C₁-C₆alkylarylsulfonamido and arylC₁-C₆alkylsulfonamido

“Alkyl” and “aryl” used for any of the groups in the above list also means substituted alkyl or substituted aryl, where substituted means groups selected from the same list.

Preferred Embodiments

A preferred solid support template of the present invention is the template of Formula 1 in which the “L” is attached to R₁, can be presented as Formula 1a, wherein

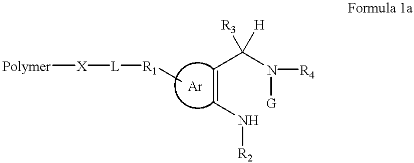

R₁ is a functional or a multifunctional group that contains two attachment points and chemically connects the template to the solid support through an appropriate spacer “L”. Example of such a functional group are “carbonyl group” [—C(O)—], oxygen (—O—) and methylene (—CH₂—). A multifunctional chemical group containing two attachment points, is selected from a group consisting of substituted alkyl, substituted alkenyl, substituted alkynyl, substituted aryl, substituted heteroaryl, substituted cycloalkyl and substituted alkylcycloalkyl; substututed heterocyclyl; substituted amino, substituted alkyloxy and substituted aryloxy.

R₂ is selected from a group consisting of hydrogen, hydroxy, substituted alkyl, substituted alkenyl, substituted alkynyl, substituted aryl, substituted heteroaryl, substituted cycloalkyl and substituted heterocyclyl;

R₃ is hydrogen, —C(O)NHR₅, substituted alkyl, substituted alkenyl, substituted alkynyl, substituted aryl, substituted heteroaryl, substituted cycloalkyl; substituted heterocyclyl;

G is selected from a group consisting of hydrogen, substituted alkylcarbonyl, substituted arylcarbonyl, substituted arylalkylcarbonyl, substituted alkyloxycarbonyl, substituted N-alkylaminocarbonyl, substituted N,N-dialkylaminocarbonyl, substituted N-arylaminocarbonyl, substituted N,N-diarylaminocarbonyl, substituted N-alkyl-N-arylaminocarbonyl, alkylthiocarbonyl, substituted arylthiocarbonyl, substituted arylalkylthiocarbonyl, substituted N-alkylaminothiocarbonyl, substituted N,N-dialkylaminothiocarbonyl, substituted N-arylaminothiocarbonyl, substituted N,N-diarylaminothiocarbonyl, substituted N-alkyl-N-arylaminothiocarbonyl, substituted alkylsulfonyl, substituted arylsulfonyl;

R₄ and R₅ are independently selected from a group consisting of hydrogen, substituted alkyl, substituted alkenyl, substituted alkynyl, substituted aryl, substituted heteroaryl, substituted cycloalkyl and substituted heterocyclyl;

Another preferred solid support template of the present invention is the template of Formula 1 in which the “L” is attached to R4, can be presented as Formula 1b, wherein

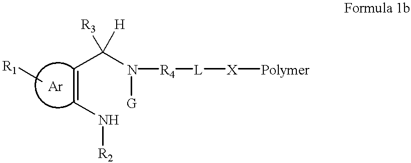

R₁ is selected from a group consisting of hydrogen, chloro, fluoro, bromo, iodo, nitro, cyano, substituted alkyl, substituted alkenyl, substituted alkynyl, substituted aryl, substituted heteroaryl, substituted cycloalkyl and substituted alkylcycloalkyl; substututed heterocyclyl; or

R₁ is selected from a group consisting of amino, substituted amino, hydroxyl, substituted hydroxyl, substituted sulfhydryl, substituted alkyl sulfonamido, substituted alkyl carboxamido, substituted alkyl ureido, substituted alkyl sulfamido, substituted alkyloxycarboxamido, substituted aryl sulfonamido, substituted aryl carboxamido, substituted aryl ureido, and substituted alkyloxycarboxamido;

R₂ is selected from a group consisting of hydrogen, hydroxy, substituted alkyl, substituted alkenyl, substituted alkynyl, substituted aryl, substituted heteroaryl, substituted cycloalkyl and substituted heterocyclyl;

R₃ is hydrogen, —C(O)NHR₅, substituted alkyl, substituted alkenyl, substituted alkynyl, substituted aryl, substituted heteroaryl, substituted cycloalkyl; substituted heterocyclyl; wherein R₅ is selected from a group consisting of hydrogen, substituted alkyl, substituted alkenyl, substituted alkynyl, substituted aryl, substituted heteroaryl, substituted cycloalkyl and substituted heterocyclyl;

G is selected from a group consisting of hydrogen, substituted alkylcarbonyl, substituted arylcarbonyl, substituted arylalkylcarbonyl, substituted alkyloxycarbonyl, substituted N-alkylaminocarbonyl, substituted N,N-dialkylaminocarbonyl, substituted N-arylaminocarbonyl, substituted N,N-diarylaminocarbonyl, substituted N-alkyl-N-arylaminocarbonyl, alkylthiocarbonyl, substituted arylthiocarbonyl, substituted arylalkylthiocarbonyl, substituted N-alkylaminothiocarbonyl, substituted N,N-dialkylaminothiocarbonyl, substituted N-arylaminothiocarbonyl, substituted N,N-diarylaminothiocarbonyl, substituted N-alkyl-N-arylaminothiocarbonyl, substituted alkylsulfonyl, substituted arylsulfonyl;

R₄ is a functional or a multifunctional group that contains two attachment points and chemically connects the nitrogen atom of the template to the solid support through an appropriate spacer “L”. An example of such a functional group is “carbonyl group” [—C(O)—]. A multifunctional chemical group containing two attachment points, is selected from a group consisting of substituted alkyl, substituted alkenyl, substituted alkynyl, substituted aryl, substituted heteroaryl, substituted cycloalkyl and substituted alkylcycloalkyl; substututed heterocyclyl; substituted amino, substituted alkyloxy and substituted aryloxy. An example of the such a multiple functional group is —C(O)CH₂CH₂C(O)—.

Another preferred solid support template of the present invention is the template of Formula 1 in which R₃ is —C(O)NHR₅, can be presented as Formula 1d, wherein

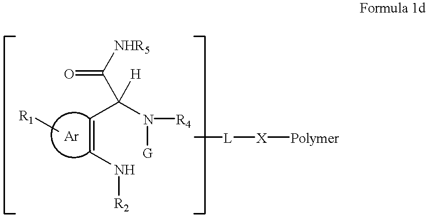

R₁ is selected from a group consisting of hydrogen, chloro, fluoro, bromo, iodo, nitro, cyano, substituted alkyl, substituted alkenyl, substituted alkynyl, substituted aryl, substituted heteroaryl, substituted cycloalkyl and substituted alkylcycloalkyl; substututed heterocyclyl; or

R₁ is selected from a group consisting of amino, substituted amino, hydroxyl, substituted hydroxyl, substituted sulfhydryl, substituted alkyl sulfonamido, substituted alkyl carboxamido, substituted alkyl ureido, substituted alkyl sulfamido, substituted alkyloxycarboxamido, substituted aryl sulfonamido, substituted aryl carboxamido, substituted aryl ureido, and substituted alkyloxycarboxamido;

R₂ is selected from a group consisting of hydrogen, hydroxy, substituted alkyl, substituted alkenyl, substituted alkynyl, substituted aryl, substituted heteroaryl, substituted cycloalkyl and substituted heterocyclyl;

G is selected from a group consisting of hydrogen, substituted alkylcarbonyl, substituted arylcarbonyl, substituted arylalkylcarbonyl, substituted alkyloxycarbonyl, substituted N-alkylaminocarbonyl, substituted N,N-dialkylaminocarbonyl, substituted N-arylaminocarbonyl, substituted N,N-diarylaminocarbonyl, substituted N-alkyl-N-arylaminocarbonyl, alkylthiocarbonyl, substituted arylthiocarbonyl, substituted arylalkylthiocarbonyl, substituted N-alkylaminothiocarbonyl, substituted N,N-dialkylaminothiocarbonyl, substituted N-arylaminothiocarbonyl, substituted N,N-diarylaminothiocarbonyl, substituted N-alkyl-N-arylaminothiocarbonyl, substituted alkylsulfonyl, substituted arylsulfonyl;

R₄ and R₅ are independently selected from a group consisting of hydrogen, substituted alkyl, substituted alkenyl, substituted alkynyl, substituted aryl, substituted heteroaryl, substituted cycloalkyl and substituted heterocyclyl;

Solid Support

Solid support is a substrate consisting of a polymer, cross-linked polymer, functionalized polymeric pin, or other insoluble material. These polymers or insoluble materials have been described in literature and are known to those who are skilled in the art of solid phase synthesis (Stewart J M, Young J. D.; Solid Phase Peptide Synthesis, 2nd Ed; Pierce Chemical Company: Rockford. Ill., 1984). Some of them are based on polymeric organic substrates such as polyethylene, polystyrene, polypropylene, polyethylene glycol, polyacrylamide, and cellulose. Additional types of supports include composite structures such as grafted copolymers and polymeric substrates such as polyacrylamide supported within an inorganic matrix such as kieselguhr particles, silica gel, and controlled pore glass.

Examples of suitable support resins and linkers are given in various reviews (Barany, G.; Merrifield, R. B. “Solid Phase Peptide Synthesis”, in “The Peptides—Analysis, Synthesis, Biology”. Vol 2, [Gross, E. and Meienhofer, J., Eds.], Academic Press, Inc., New York, 1979, pp 1-284; Backes, B. J.; Ellman, J. A. Curr. Opin. Chem. Biol. 1997. 1, 86; James, I. W., Tetrahedron 1999, 55, 4855-4946) and in commercial catalogs (Advanced ChemTech, Louisville, Ky.; Novabiochem, San Diego, Calif.). Some examples of particularly useful functionalized resin/linker combinations that are meant to be illustrative and not limiting in scope are shown below:

(1) Aminomethyl polystyrene resin (Mitchell, A. R., et al., J. Org. Chem., 1978, 43, 2845):

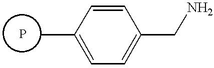

This resin is the core of a wide variety of synthesis resins. The amide linkage can be formed through the coupling of a carboxylic acid to amino group on solid support resin under standard peptide coupling conditions. The amide bond is usually stable under the cleavage conditions for most acid labile, photo labile and base labile or nucleophilic linkers.

(2) Wang resin (Wang, S. S.; J. Am. Chem. Soc. 1973, 95, 1328

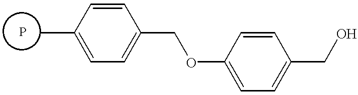

-1333). Wang resin is perhaps the most widely used of all resins for acid substrates bound to the solid support resin. The linkage between the substrate and the polystyrene core is through a 4-hydroxybenzyl alcohol moiety. The linker is bound to the resin through a phenyl ether linkage and the carboxylic acid substrate is usually bound to the linker through a benzyl ester linkage. The ester linkage has good stability to a variety of reaction conditions, but can be readily cleaved under acidic conditions, such as by using 25% TFA in DCM.

(3) Rink resin (Rink, H.; Tetrahedron Lett. 1987, 28, 3787).

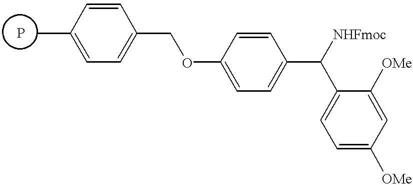

Rink resin is used to prepare amides utilizing the Fmoc strategy. It has also found tremendous utility for a wide range of solid phase organic synthesis protocols. The substrate is assembled under basic or neutral conditions, then the product is cleaved under acidic conditions, such as 10%TFAinDCM.

(4) Knorr resin (Bernatowicz, M. S., et al. Tetrahedron Lett., 1989, 30, 4645).

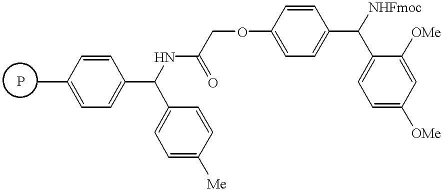

Knorr resin is very similar to Rink resin, except that the linker has been modified to be more stable to TEA.

(5) PAL resin (Bernatowicz, M. S., et al. Tetrahedron lett., 1989, 30,

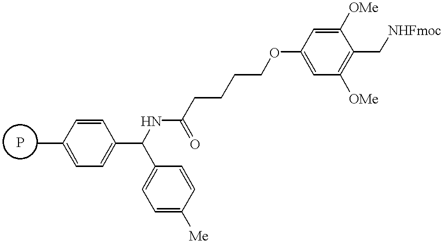

4645).

(6) HMBA-MBHA Re sin (Sheppard, R. C., et al., xt. J. Peptide Protein Res. 1982, 20, 451).

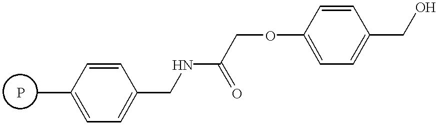

(7) HMPA resin. This also is an acid labile resin which provides an alternative to Wang resin and represented as:

(8) Benzhydrylamine copoly(styrene-1 or 2%-divinylbenzene) which referred to as the BHA resin (Pietta, P. G., et al., J. Org. Chem. 1974, 39, 44).

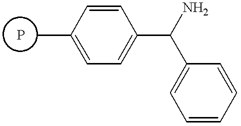

(9) Methyl benzhydrylamine copoly(styrene-1 or 2%-divinylbenzene) which is referred to as MBHA and represented as:

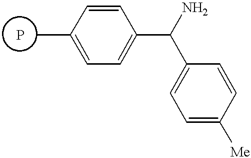

(10) Trityl and functionalized Trityl resins, such as aminotrityl resin and amino-2-chlorotrityl resin (Barlos, K.; Gatos, D.; Papapholiu, G.; Schafer, W.; Wenqing, Y.; Tetrahedron Lett. 1989, 30, 3947).

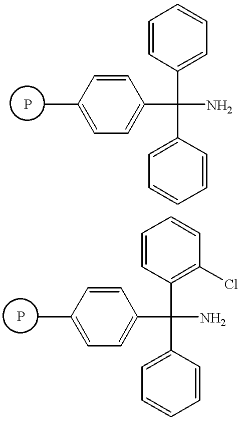

(11) Sieber amide resin (Sieber, P.; Tetrahedron Lett. 1987, 28, 2107).

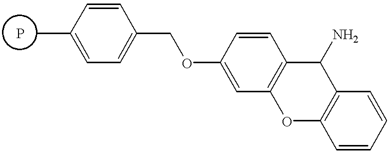

(12) Rink acid resin (Rink, H., Tetrahedron Lett., 1987, 28, 3787).

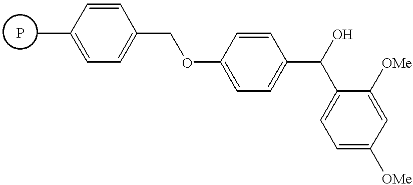

(13) HMPB-BPH resin (4-hydroxymethyl-3-methoxyphenoxybutynic

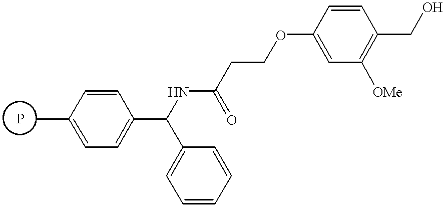

acid-BPH Florsheimer, A.; Riniker, B. in “Peptides 1990; Proceedings of the 21^{st} European Peptide Symposium”, [Giralt, E. and Andreu, D. Eds.], ESCOM, Leiden, 1991, pp 131.

(14) Merrifield resin—Chloromethyl co-poly(styrene-1 or 2%-divinylbenzene) which can be represented as:

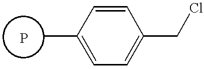

A carboxylic acid substrate is attached to the resin through nucleophilic replacement of chloride under basic conditions. The resin is usually stable under acidic conditions, but the products can be cleaved under basic and nucleophilic conditions in the presence of amine, alcohol, thiol and H₂O.

(15) Hydroxymethyl polystyrene resin (Wang, S. S., J. Org. Chem., 1975, 40, 1235).

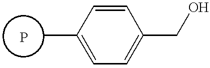

The resin is an alternative to the corresponding Merrifield resin, whereas the substrate is attached to a halomethylated resin through nucleophilic displacement of halogen on the resin, the attachment to hydroxymethylated resins is achieved by coupling of activated carboxylic acids to the hydroxy group on the resin or through Mitsunobu reactions. The products can be cleaved from the resin using a variety of nucleophiles, such as hydroxides, amines or alkoxides to give carboxylic acids, amides and esters.

(16) Oxime resin (DeGrado, W. F.; Kaiser, E. T.; J. Org. Chem. 1982, 47, 3258).

This resin is compatible to Boc chemistry. The product can be cleaved under basic conditions.

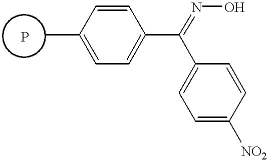

(16) Photolabile resins (e.g. Abraham, N. A. et al.; Tetrahedron Lett. 1991, 32, 577). The products can be cleaved from these resins photolytically under neutral or mild conditions, making these resins useful for preparing pH sensitive compounds. Examples of the photolabile resins include

(a) ANP resin:

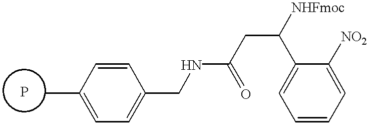

(b) alpha-bromo-alpha-methylphenacyl polystyrene resin:

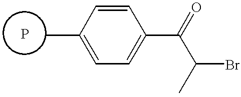

(17) Safety catch resins (see resin reviews above; Backes, B. J.; Virgilio, A. A.; Ellman, J. Am. Chem. Soc. 1996, 118, 3055-6). These resins are usually used in solid phase organic synthesis to prepare carboxylic acids and amides, which contain sulfonamide linkers stable to basic and nucleophilic reagents. Treating the resin with haloacetonitriles, diazomethane, or TMSCHN₂ activates the linkers to attack, releasing the attached carboxylic acid as a free acid, an amide or an ester depending on whether the nucleophile is a hydroxide, amine, or alcohol, resepectively. Examples of the safty catch resins include:

(a) 4-sulfamylbenzoyl-4′-methylbenzhydrylamine resin:

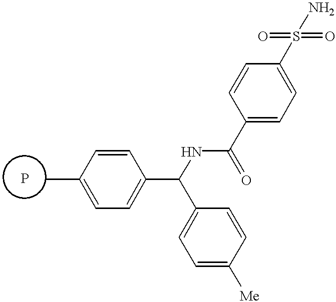

(b) 4-sulfamylbutryl-4′-methylbenzhydrylamine resin:

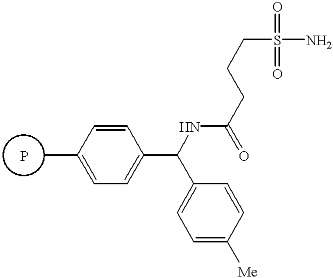

(18) TentaGel resins:

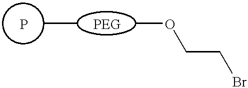

TentaGel resins are polyoxyethyleneglycol (PEG) grafted (Tentagel) resins (Rapp, W.; Zhang, L.; Habich, R.; Bayer, E. in “Peptides 1988; Proc. 20^{tth} European Peptide Symposium” [Jung, G. and Bayer, E., Eds.], Walter de Gruyter, Berlin, 1989, pp 199-201. TentaGel resins, e.g. TentaGel S Br resin can swell in a wide variety of solvents and the bead size distribution is very narrow, making these resins ideal for solid phase organic synthesis of combinatorial libraies. TentaGel S Br resin can immobilize carboxylic acids by displacing the bromine with a carboxylic acid salt. The products can be released by saponification with dilute aqueous base.

(19) Resins with silicon linkage (Chenera, B.; Finkelstein, J. A.; Veber, D. F.; J. Am. Chem. Soc. 1995, 117, 11999-12000; Woolard, F. X.; Paetsch, J.; Ellmnan, J. A.; J. Org. Chem. 1997, 62, 6102-3). Some examples of these resins contain protiodetachable arylsilane linker and traceless silyl linker. The products can be released in the presence of fluoride.

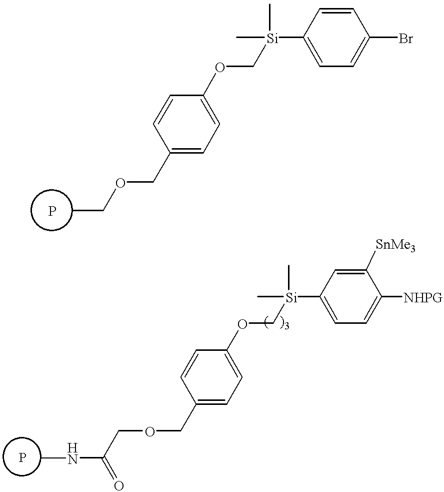

Also useful as a solid phase support in the present invention are solubilizable resins that can be rendered insoluble during the synthesis process as solid phase supports. Although this technique is frequently referred to as “Liquid Phase Synthesis”, the critical aspect for our process is the isolation of individual molecules from each other on the resin and the ability to wash away excess reagents following a reaction sequence. This also is achieved by attachment to resins that can be solubilized under certain solvent and reaction conditions and rendered insoluble for isolation of reaction products from reagents. This latter approach, (Vandersteen, A. M.; Han, H.; Janda, K. D.; Molecular Diversity, 1996, 2, 89-96.) uses high molecular weight polyethyleneglycol as a solubilizable polymeric support and such resins are also used in the present invention.

Preparation of the templates:

Schemes 1-4 illustrate general methods for the preparation of the solid support 2-aminoarylmethylamine templates according to the invention.

Scheme 1 describes the method for the preparation of the solid support 2-aminoarylmethylamine template of Formula 1a. Readily available building blocks of formula 1-1 containing a leaving group “Y” and an ortho-substitute on the aromatic ring, such as nitro, fluoro or N-protected amino group, are loaded onto solid support by coupling R₁ with “L”. Subsequently, amine displacement followed by introducing “G” group gives polymer-bound intermediate of formula 1-5. The desired 2-aminoarylmethylamine template of Formula 1a can then be obtained upon reduction or displacement or deprotection depending the substitute group “X” as shown in Scheme 1.

Scheme 2 describes the method for the preparation of the solid support 2-aminoarylmethylamine template of Formula 1b. Polymer-bound amines of formula 2-1 are alkylated either by N-reductive akylation with building blocks of formula 2-2 or by N-alkylation with building blocks of formula 2-3. Similar to the preparation of the template 1a, the desired 2-aminoarylmethylamine template of Formula 1b can then be obtained by coupling “G” followed by an appropriate chemical manipulation depending on the substitute group “X” as shown in Scheme 2.

Scheme 3 describes the method for the preparation of the solid support 2-aminoarylmethylamine template of Formula 1c. Arylmethylamine building blocks of formula 3-1 are easily loaded onto solid support via an amide or carbamide linkage to form intermediates of formula 3-3. The template Ic is then achieved by a similar conversion of the group “X” into the amine.

Scheme 4 describes the method for the preparation of the solid support 2-aminoarylmethylamine template of formula 1d. In this case, Ugi four-component condensation reaction is utilized to generate polymer-bound key intermediates with a generic structure of formula 4-9. Wherein, one of the groups (R₁, R₄, R₅ and R₆) must be linked to the polymer. This depends on what polymer-bound building block is used in the Ugi condensation reaction. For example, the reaction of the polymer-bound aldehyde (4-1) with an amine (4-6), an isocyanide (4-7) and an acid (4-8) gives the intermediate 4-9 with R₁ attaching to the polymer. The intermediate 4-9 can be converted into the desired template of Formula 1d by an appropriate chemical manipulation depending on the substitute group “X” as shown in Scheme 4.

Synthesis of novel heterocyclic scaffolds using the templates:

Schemes 5 outlines a general approach to the solid-phase synthesis of a variety of novel scaffolds containing pharmaceutically important heterocyclic rings based on the solid-support 2-aminoarylmethylamine templates. Through a plurality of chemical reactions, the two nitrogen atoms of the 2-aminoarylmethylamine template of Formula 1 can be bridged to form a variety of polymer-bound heterocyclic scaffolds of formula 5-2. The heterocyclic scaffolds include, but not limited to 3,4-dihydroquinazoline, quinazoline, 1,4-benzodiazepine-2-one, 1,4-benzodiazepine-3-one, 3,4-dihydro-2-quinazolinone and 3,4-dihydroquinazoline-2-thione.

Schemes 6 and 7 describe reaction sequences for the preparation of highly functionalized 3,4-dihydroquinazolines, quinazolines and tetrahydroquinazolines that are presented in the generic structures of formula 6-1,2-2 and 7-1.

Scheme 8 describes a reaction sequence for the preparation of highly functionalized 2-amino-3,4-dihydroquinazolines and 2-aminoquinazolines that are presented in the generic structures of formula 8-1 and 8-2.

Scheme 9 describes a reaction sequence for the preparation of highly functionalized 1,4-benzodiazepine-3-one which is presented in the generic structure of formula 9-2.

Scheme 10 describes a reaction sequence for the preparation of highly functionalized 1,4-benzodiazepine-2-one which is presented in the generic structure of formula 10-2.

Scheme 11 describes a reaction sequence for the preparation of highly functionalized, 3,4-dihydro-2-quinazolinone and 3,4-dihydroquinazoline-2-thione, 2-thioalkyl-3,4-dihydroquinazolines, 2-thioalkylquinazolines that are presented in the generic structures of formula 11-1, 11-2, 11-3 and 11-4.

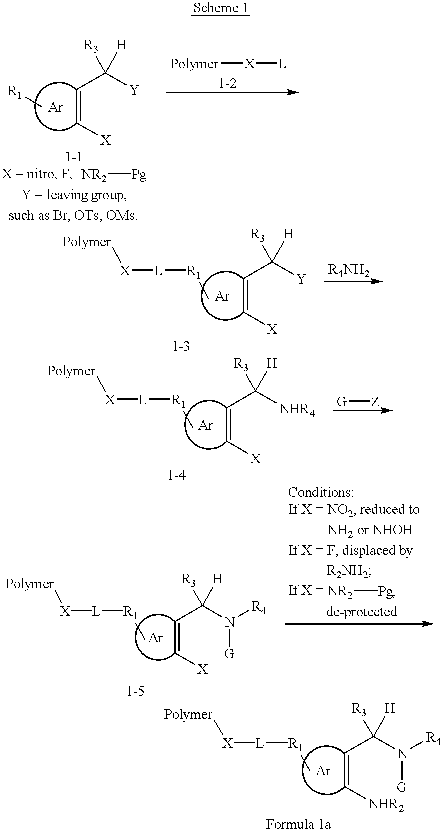

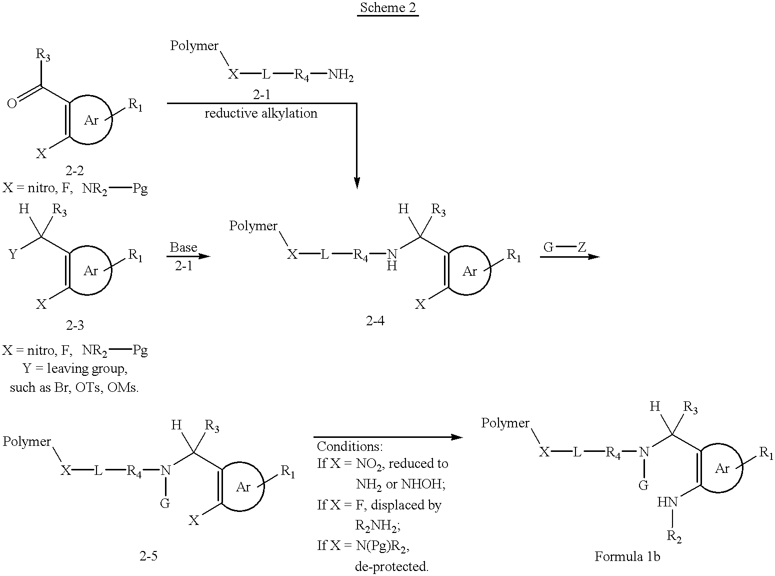

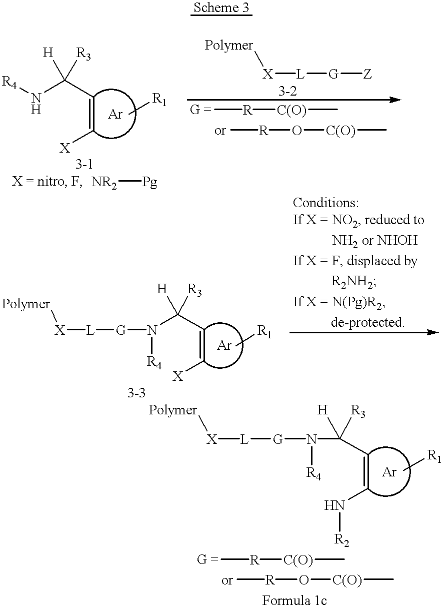

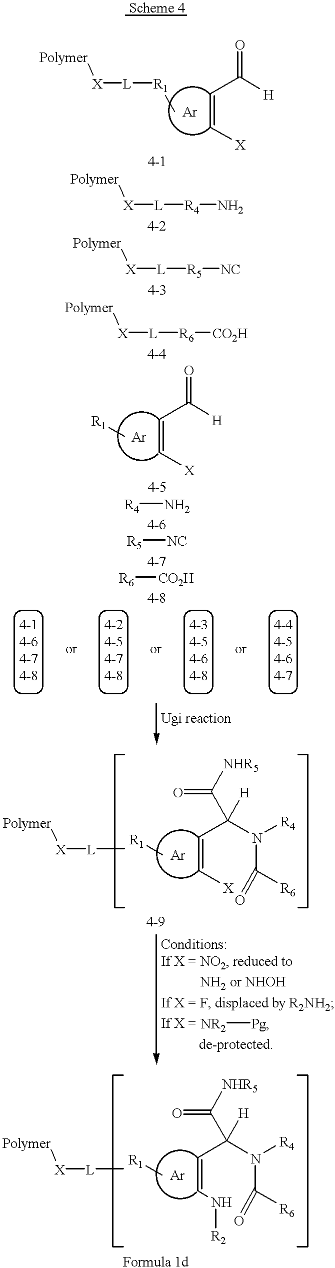

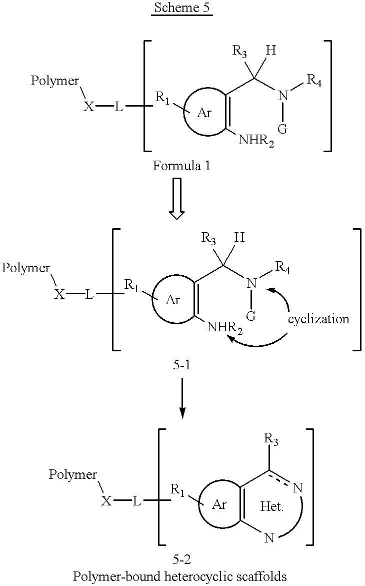

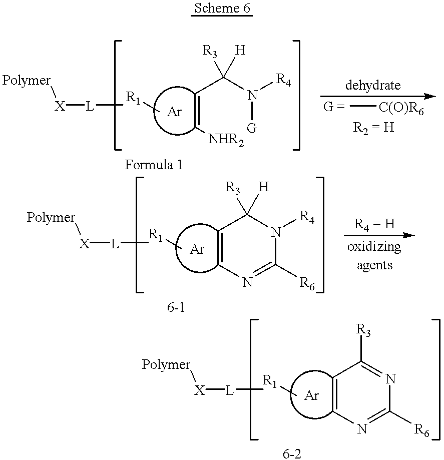

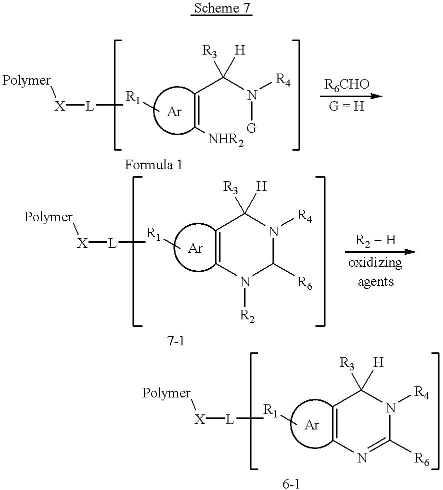

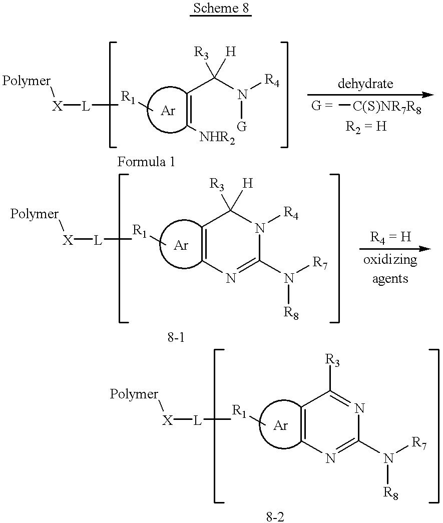

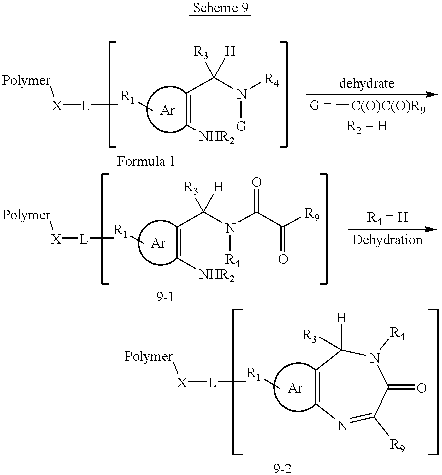

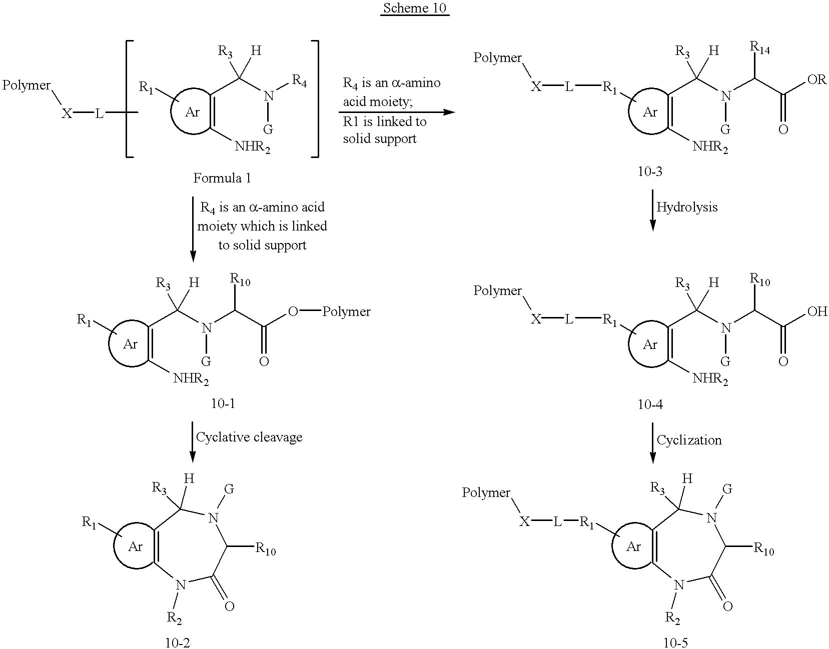

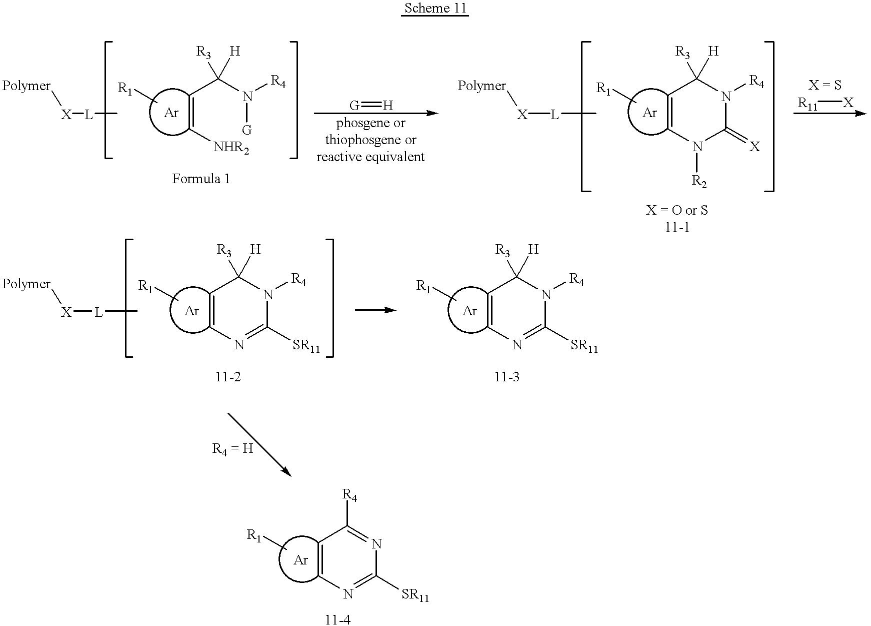

### EXAMPLES

The following examples (FIGS.1-5 ) are by way of illustration of various aspects of the present invention and are not intended to be limiting thereof.

General Procedures-Reagent Systems and Test Methods

Anhydrous solvents were purchased from Aldrich Chemical Company and used directly. Resins were purchased from Advanced ChemTech, Louisville, Ky., and used directly. The loading level ranged from 0.30 to 1.0 mmol/g. Unless otherwise noted, reagents were obtained from commercial suppliers and used without further purification. IR spectra were obtained on a Midac M1700 and absorbencies are listed in inverse centimeters. HPLC/MS analysis were performed on a Hewlett Packard 1100 with a photodiode array detector coupled to a Micros Platform II electrospray mass spectrometer. An evaporative light scattering detector (Sedex 55) was also incorporated for more accurate evaluation of sample purity. Reverse phase columns were purchased from YMC, Inc. (ODS-A, 3 μm, 120 Å, 4.0×50 mm).

Solvent system A consisted of 97.5% acetonitrile, 2.5% H20, and 0.05% TFA. Solvent system B consisted of 97.5% H₂O, 2.5% acetonitrile, and 0.05% TFA. Samples were typically acquired at a mobile phase flow rate of 2 ml/min involving a 2 minute gradient from solvent B to solvent A with 5 minute run times. Resins were washed with appropriate solvents (100 mg of resin/1 ml of solvent). Technical grade solvents were used for resin washing.

### Examples of the Polymer-bound Template of Formula 1a

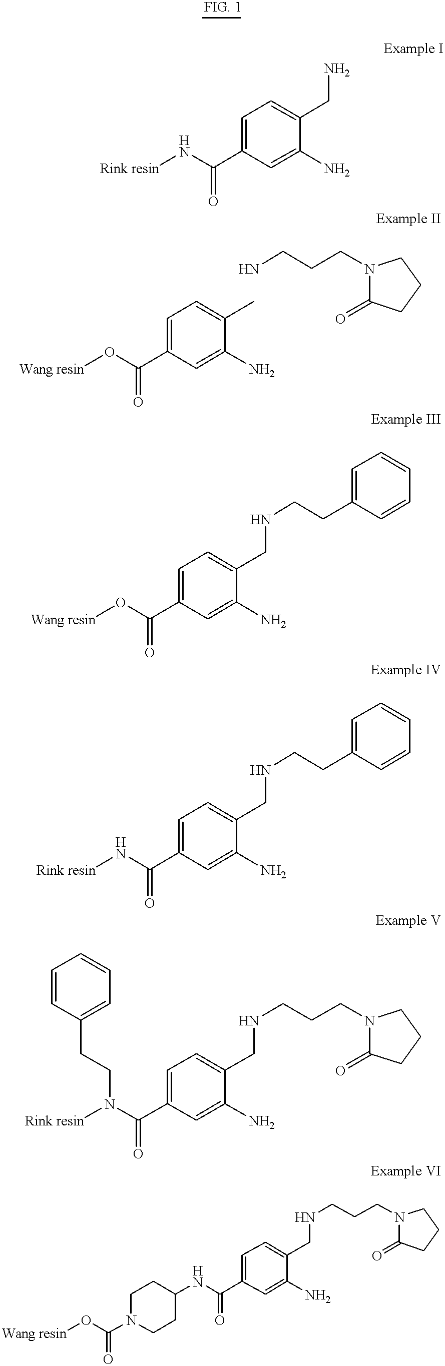

### Examples of the Polymer-bound Template of Formula 1a

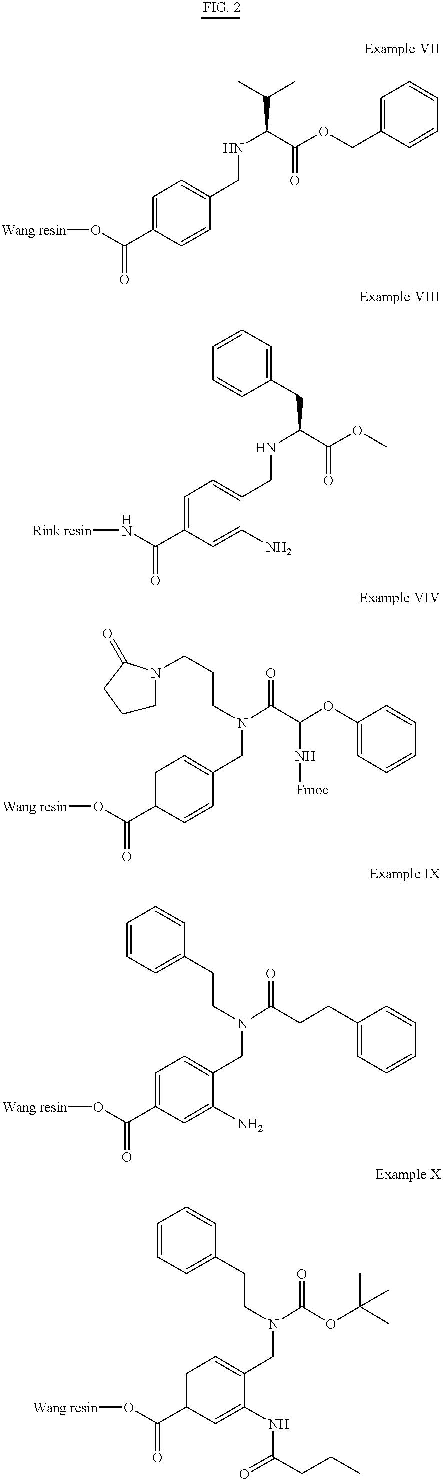

### Examples of the Polymer-bound Templates of Formula 1b, 1c and 1d

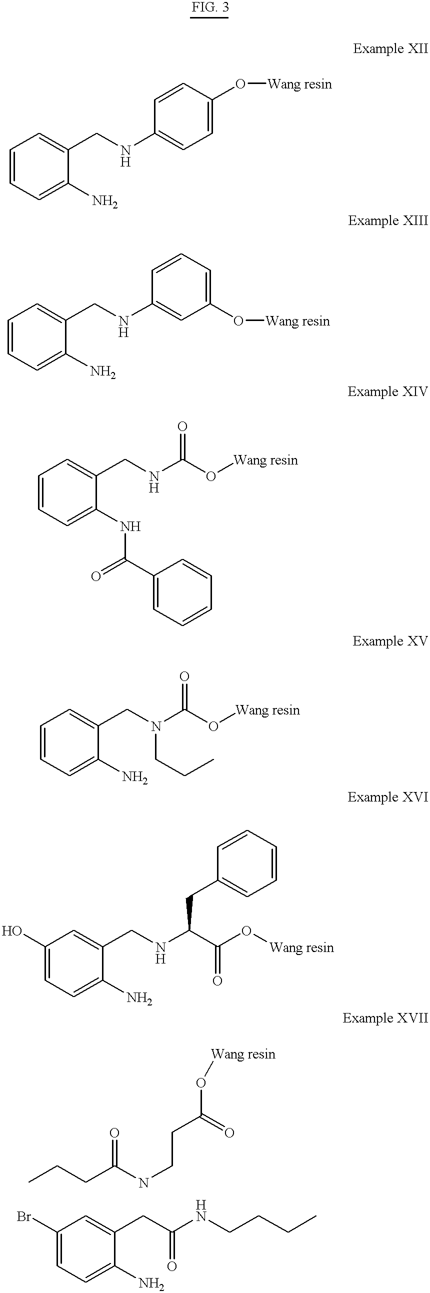

### Examples of the Heterocyclic Compounds

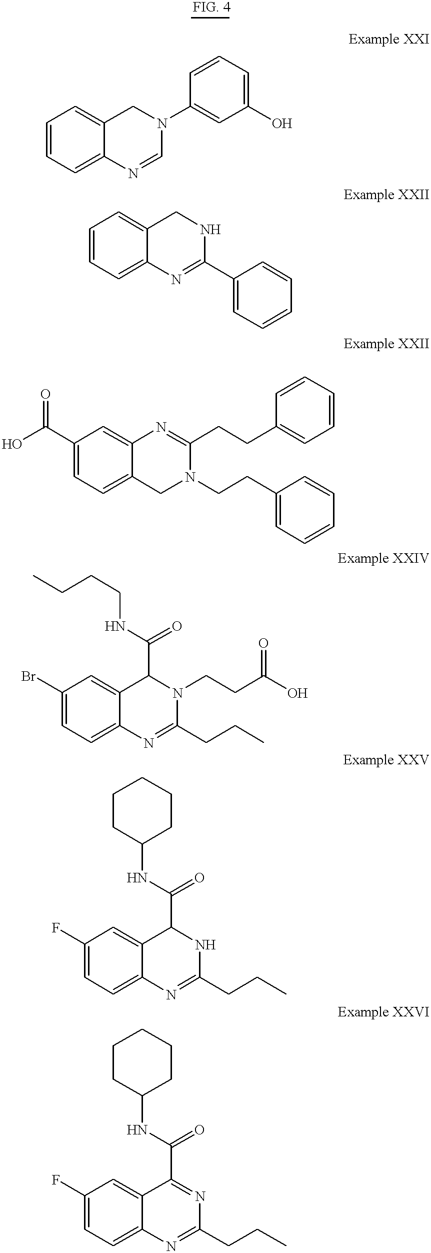

### Examples of the Heterocyclic Compounds

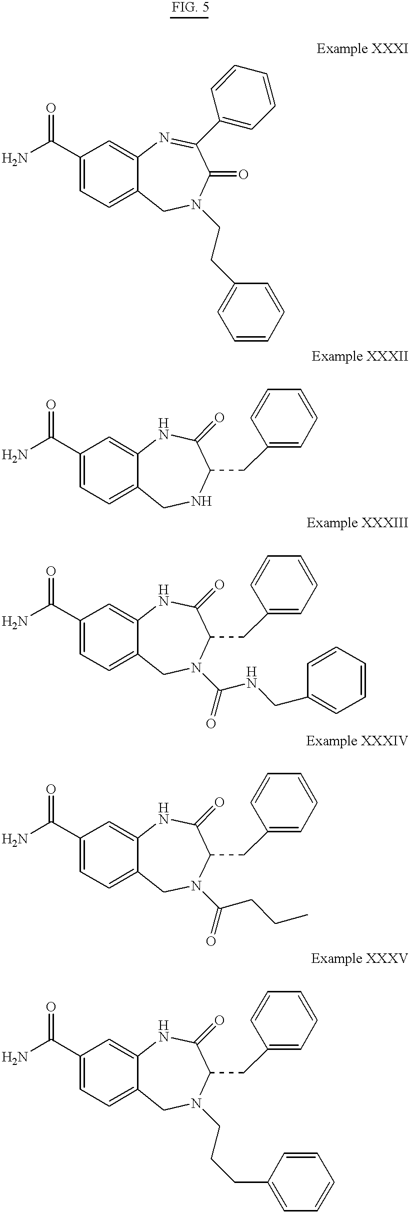

### Example I: 3-amino-4-(aminomethyl)-benzoic Acid Rink Resin

4-(bromomethyl)-3-nitrobenzoic acid Rink resin: Fmoc-protected Rink resin (1.2 g, 0.7 mmol/g, 0.84 mmol) was treated with 5 mL of 20% piperidine in DMF for 30 minutes at room temperature and washed several times with DMF, MeOH, and DCM. The deprotected resin was then treated with 4-(bromomethyl)-3-nitrobenzoic acid (0.655 g, 2.52 mmol) and 10 mL of THF. DIC (0.395 mL, 2.52 mmol) was then added. The resulting slurry was shaken at room temperature for 4 h. The resin was filtered and washed with DMF (3×), MeOH (3×) and DCM (3×), MeOH (2×). After drying in air, a small amount of the obtained 4-(bromomethyl)-3-nitrobenzoic acid Rink resin was subjected to the Kaiser test which indicated negative. LC-MS analysis of a sample cleaved from 10 mg of the resin (20% TFA in DCM, 20 min) confirmed the desired 4-(bromomethyl)-3-nitrobenzamide [MS (ES) m/e: 261, M+H⁺].

The above resin (250 mg, ˜0.175 mmol) was added to a mixture of Bu4NHSO4 and NaN3 in 3:1 DCM/H20 (3.3 mL). The slurry was shaken for 45 min. The resin was filtered followed by washing with DMF (3×), THF/H20 (3×), MeOH (3×), DCM (3×), MeOH (3×). The resin was dried in air for 2 h. IR (KBr): 2107 cm⁻¹.

The azide resin was then treated with 3 mL of 2 M SnCl₂.2H₂O in NMP overnight. The resin was filtered and washed with DMF (3×), MeOH (3×), DCM (3×) and MeOH (3×). A small amount of the resin (5 mg) was treated with 20% TFA in DCM (20 min). The cleavage solution was concentrated to give a residue which was analyzed by LC-MS. The expected 3-amino-4-(aminomethyl)benzamide was confirmed (>95% purity; retention time, 0.25 min; MS (ES) m/e: 166, M+H⁺].

### Example II: 3-amino-4-[3- (2-oxopyrrolidinyl)Propylaminomethyl)-benzoic Acid Wang Resin

4-(bromomethyl)-3-nitrobenzoic acid Wang resin: Wang resin (12 g, 0.7 mmol/g) was treated with 4-(bromomethyl)-3-nitrobenzoic acid (6.55 g, 38.4 mmol) and 120 mL of THF. After the acid was dissolved completely, HOBt (1.28 g, 8.4 mmol), DIC (0.395 mL, 3.84 mmol) and DMAP (102 mg, 0.84 mmol) were then added in order. The resulting slurry was shaken at room temperature for 4 h. The resin was filtered and washed with DMF (3×), MeOH (3×) and DCM (3×), MeOH (2×). After drying in air, a small amount of the obtained 4-(bromomethyl)-3-nitrobenzoic acid Wang resin was treated with 20% TFA in DCM for 30 min. The cleavage solution was concentrated and co-evaporated with acetonitrile once to give a residue which was analyzed by ¹HNMR to confirm 4-(bromomethyl)-3-nitrobenzoic acid.

The above resin (1 g, ˜0.6 mmol) was mixed with 10 mL of 1M of 1-(3-aminopropyl)-2-pyrrolidinone solution in NMP. The slurry was shaken at room temperature for 45 min. The resin was the filtered and washed with DMF (3×), MeOH (3×), DCM (3×) and MeOH (3×). After drying in air for 1 h, a small amount of the obtained resin was subjected to the TFA cleavage (20% TFA in DCM, 30 min). LC-MS analysis confirmed the cleavage of the desired 4-[3-(2-oxopyrrolidinyl)propylaminomethyl)-3-nitrobenzoic acid from Wang resin in >90% purity [retention time: 2.16, MS (ES) m/e: 322, M+H⁺].

The resin (200 mg) obtained above was treated 3 mL of 2 M SnCl₂.2H₂O in NMP overnight. The resin was filtered and washed with DMF (3×), MeOH (3×), DCM (3×) and MeOH (3×). A small amount of the resin (5 mg) was treated with 20% TFA in DCM (30 min). The cleavage solution was concentrated to give a residue which was analyzed by LC-MS. The expected 3-amino-4-[3-(2-oxopyrrolidinyl)propylaminomethyl)-benzamide was confirmed [>85% purity; retention time, 2.37 min; MS (ES) m/e (relative intensity): 292 (M+H⁺, 40)].

### Example III: 3-amino-4-(Phenethylaminomethyl)-benzoic Acid Wang Resin

The same procedure for the preparation of Example II was followed except that phenethyl amine was used instead of 1-(3-aminopropyl)-2-pyrrolidinone. A small amount of the resin (5 mg) was treated with 20% TFA in DCM (30 min). The cleavage solution was concentrated to give a residue which was analyzed by LC-MS. The expected 3-amino-4-(phenethylaminomethyl)benzoic acid was confirmed [>95% purity; retention time, 2.63 min; MS (ES) m/e (relative intensity): 272 (M+H⁺, 10), 150 (100)].

### Example IV: 3-amino-4-(Phenethylaminomethyl)-benzoic Acid Rink Resin

4-(bromomethyl)-3-nitrobenzoic acid Rink resin (to see the Example I) (0.6 g, ˜0.6 mmol/g, 0.36 mmol) was mixed with 6 mL of 1M of phenethylamine solution in NMP. The slurry was shaken at room temperature for 45 min. The resin was the filtered and washed with DMF (3×), MeOH (3×), DCM (3×) and MeOH (3×). After drying in air for 1 h, a small amount of the obtained resin was subjected to the TFA cleavage (20% TFA in DCM, 30 min). LC-MS analysis confirmed the desired 4-(phenethylamino)-3-nitrobenzamide in >95% purity.

The above resin was then treated 10 mL of 2 M SnCl₂.2H₂O in NMP overnight. The resin was filtered and washed with DMF (3×), MeOH (3×), DCM (3×) and MeOH (3×). A small amount of the resin (5 mg) was treated with 20% TFA in DCM (30 min). The cleavage solution was concentrated to give a residue which was analyzed by LC-MS. The expected 3-amino-4-(phenethylamino)benzamide was confirmed [>95% purity; retention time, 2.54 min; MS (ES) m/e (relative intensity): 270 (M+H⁺, 40), 149 (100)].

### Example V: Phenethyl 3-amino-4-[3-(2-oxopyrrolidinyl)-propylaminomethyl)-benzamide Rink Resin

Phenethylamine Rink resin: Rink chloride resin (1.09 g, 0.8 mmol) was mixed with a 1 M solution of phenethylamine in NMP (6 mL) and a 1 M solution of DIEA in NMP (6 mL). The slurry was shaken at rt for 20 h. Filtration followed by washing with DMF (3×), MeOH (3×), DCM (3×) and MeOH (3×), gave the desired amine Rink resin resin which was dried in vacuo.

The resin prepared above (600 mg, 0.36 mmol) was mixed with THF (6 mL). To the suspension were added 4-(bomomethyl)-3-benzoic acid (870 mg, 3.34 mmol) and DIC (0.522 mL, 3.34 mmol) in order. The slurry was shaken at rt for 4 h. The resin was filtered and washed with DMF (3×), MeOH (3×), DCM (3×) and MeOH (3×). After drying in air for 1 h, a small amount of the obtained resin was subjected to the TFA cleavage (20% TFA in DCM, 15 min). LC-MS analysis confirmed the desired phenethyl 4-(bromomethyl)-3-nitrobenzamide in >95% purity.

The resin (300 mg, ˜0.18 mmol) was mixed with 3 mL of 1M of 1-(3-aminopropyl)-2-pyrrolidinone solution in NMP. The slurry was shaken at room temperature for 45 min. The resin was the filtered and washed with DMF (3×), MeOH (3×), DCM (3×) and MeOH (3×).

The dried resin obtained above was then treated 3 mL of 2 M SnCl₂.2H₂O in NMP overnight. The resin was filtered and washed with DMF (3×), MeOH (3×), DCM (3×) and MeOH (3×). A small amount of the resin (5 mg) was treated with 20% TFA in DCM (20 min). The cleavage solution was concentrated to give a residue which was analyzed by LC-MS. The expected phenethyl 3-amino-4-[3-(2-oxopyrrolidinyl)-propylaminomethyl)benzamide was confirmed [>90% purity; retention time, 2.70 min; MS (ES) m/e (relative intensity): 396 (M+H⁺, 100)].

### Example VI: 4-{3-amino-4-[3-(2-oxopyrrolidinyl)-propylaminomethyl)Benzamido} Piperidine Carbamate Wang Resin

The same procedure for the preparation of Example V was followed except that 4-aminopiperidine carbamate Wang resin was used instead of phenethylamine Rink resin. A small amount of the resin (5 mg) was treated with 20% TFA in DCM (30 min). The cleavage solution was concentrated to give a residue which was analyzed by LC-MS. The expected 4-{3-amino-4-[3- (2-oxopyrrolidinyl)-propylaminomethyl)benzamido} piperidine was confirmed [>95% purity; retention time, 2.48 min; MS (ES) m/e (relative intensity): 353 (M+H⁺, 60), 232 (100)].

### Example VII: 3-amino-4-((S)-1-benzyloxycarbonyl-2-methylpropylamino Methyl)Benzoic Acid Wang Resin

To 4-(bromomethyl)-3-nitrobenzoic acid Wang resin (to see the Example II) (1 g, ˜0.7 mmol) was added 10 mL of NMP. L-Valine benzyl ester 4-toluenesulfonate salt (1.9g, 5.0 mmol) and Diisopropylethylamine (1.8 mL) were then added. The resulting slurry was shaken at room temperature for 45 min. The resin was the filtered and washed with DMF (3×), MeOH (3×), DCM (3×) and MeOH (3×). After drying in air for 1 h, a small amount of the obtained resin was subjected to the TFA cleavage (20% TFA in DCM, 30 min). LC-MS analysis confirmed the desired 4-((S)-1-benzyloxycarbonyl-2-methylpropylamino methyl)-3-nitrobenzoic acid in >95% purity [MS (ES) m/e: 386, M+H⁺].

The resin (500 mg) obtained above was treated 5 mL of 2 M SnCl₂.2H₂O in NMP overnight. The resin was filtered and washed with DMF (3×), MeOH (3×), DCM (3×) and MeOH (3×). A small amount of the resin (5 mg) was treated with 20% TFA in DCM (30 min). The cleavage solution was concentrated to give a residue which was analyzed by LC-MS. The expected 3-amino-4-((S)-1-benzyloxycarbonyl-2-methylpropyl-amino methyl)benzoic acid was confirmed [>90% purity; retention time, 2.75 min; MS (ES) m/e (relative intensity): 357 (M+H⁺, 40), 150 (100)].

### Example VIII: 3-amino-4-((S)-1-methoxycarbonyl-2-phenylethylamino Methyl)Benzoic Acid Rink Resin

To 4-(bromomethyl)-3-nitrobenzoic acid Rink resin (to see the Example IV) (0.6 g, ˜0.7 mmol) was added a IM solution of L-phenylalanine methyl ester hydrochloride salt in NMP (6 mL) and a 2 M solution of DIEA in NMP (3 mL). The resulting slurry was shaken at room temperature for 60 min. The resin was the filtered and washed with DMF (3×), MeOH (3×), DCM (3×) and MeOH (3×). After drying in air for 1 h, a small amount of the obtained resin was subjected to the TFA cleavage (20% TFA in DCM, 30 min). LC-MS analysis confirmed the desired 4-((S)-1-methoxycarbonyl-2-phenylethylaminomethyl)-3-nitrobenzamide in >95% purity [MS (ES) m/e: 358, M+H⁺].

The resin obtained above was then treated 6 mL of 2 M SnCl₂.2H₂O in NMP overnight. The resin was filtered and washed with DMF (3×), MeOH (3×), DCM (3×) and MeOH (3×). A small amount of the resin (5 mg) was treated with 20% TFA in DCM (30 min). The cleavage solution was concentrated to give a residue which was analyzed by LC-MS. The expected 3-amino-4-((S)-1-methoxycarbonyl-2-phenylethyl-amino methyl)benzamide was confirmed [>90% purity, MS (ES) m/e (relative intensity): 328 (M+H⁺, 100)].

### Example VIV: 3-amino-4-(N-3-(2-oxopyrrolidinyl)Propyl-N-(Fmoc Phenylalanine)Aminomethyl)Benzoic Acid Wang Resin

To 4-[3-(2-oxopyrrolidinyl)propylaminomethyl)-3-nitrobenzoic acid Wang resin (to see Example II) (200 mg, 0.14 mmol) were added a solution of 1 M Fmoc Phe-OH in DMF (1.4 mL) and a solution of 1 M DIC in DCM (1.4 mL). The resulting suspension was shaken at rt overnight. The resin was the filtered and washed with DMF (3×), MeOH (3×), DCM (3×) and MeOH (3×). After drying in air for 1 h, a small amount of the obtained resin was subjected to the TFA cleavage (20% TFA in DCM, 30 min). LC-MS analysis confirmed the desired 4-(N-3-(2-oxopyrrolidinyl)propyl-N-(Fmoc phenylalanine)aminomethyl)-3-nitro-benzoic acid in >95% purity.

The resin obtained above was then treated 2 mL of 2 M SnCl₂.2H₂O in NMP overnight. The resin was filtered and washed with DMF (3×), MeOH (3×), DCM (3×) and MeOH (3×). A small amount of the resin (5 mg) was treated with 20% TFA in DCM (30 min). The cleavage solution was concentrated to give a residue which was analyzed by LC-MS. The expected 3-amino-4-[N-3-(2-oxopyrrolidinyl)propyl-N-(Fmoc phenylalanine)aminomethyl]benzoic acid was confirmed [>90% purity; retention time, 3.26 min; MS (ES) m/e (relative intensity): 661 (M+H⁺, 100)].

### Example IX: 3-amino-4-(N-(3-phenylpropionic)Phenethylaminomethyl)-benzoic Acid Wang Resin

The same procedure for the preparation of Example VIV was followed. The starting resin was 4-[(phenethylamino)methyl]-3-nitrobenzoic acid Wang resin (to see Example III). The carboxylic acid was 3-phenylpropionic acid. The final resin product was confirmed by LC-MS analysis of TFA cleavage residue from a small amount of the resin [>95% purity; retention time, 2.88 min; MS (ES) m/e (relative intensity): 403 (M+H+, 70), 150 (100)].

### Example X: 3-Butyramido-4-(N-Boc-phenethylaminomethyl)-benzoic Acid Wang Resin

To 4-[(phenethylamino)methyl]-3-nitrobenzoic acid Wang resin (to see Example III) (200 mg, 0.14 mmol) was added a solution of 1 M (Boc)20 in DCM (1 mL) and a solution of 1 M DIEA in DCM (1 mL). The slurry was shaken at room temperature overnight. The resin was the filtered and washed with DMF (3×), MeOH (3×), DCM (3×) and MeOH (3×). After drying in vacuo, the resin was used in the next step.

To the resin was added 3 mL of a mixture of pyridine and DCM (1:3). Butyric chloride (1.4 mmol) was added. The resulting slurry was shaken at rt for 5 h. The resin was filtered and washed with DMF (3×), MeOH (3×), DCM (3×) and MeOH (3×). A small amount of the resin (5 mg) was treated with 20% TFA in DCM (30 min). The cleavage solution was concentrated to give a residue which was analyzed by LC-MS. The expected 3-Butyramido-4-(phenethylaminomethyl)benzoic acid was confirmed [>90% purity; MS (ES) m/e: 341 (M+H⁺, 60)]

### Example XI: 3-Amino-4-f N-(Benzylaminothiocarbonyl)-phenethylaminomethyl]Benzoic Acid Wang Resin

To 4-[(phenethylamino)methyll-3-nitrobenzoic acid Wang resin (to see Example III) (200 mg, 0.14 mmol) was added a solution of 1 M benzylisothiocyanate in DCE (2 mL). The slurry was shaken at room temperature 7 h. The resin was the filtered and washed with DMF (3×), MeOH (3×), DCM (3×) and MeOH (3×). After drying in air for 1 h, a small amount of the obtained resin was subjected to the TFA cleavage (20% TFA in DCM, 30 min). LC-MS analysis confirmed the desired 4-[N-(benzylaminothiocarbonyl)-phenethylaminomethyl]-3-nitrobenzoic acid in >95% purity [retention time: 3.30 min, MS (ES) m/e: 449 (M+H⁺, 100)].

To the resin obtained above was then treated 2 mL of 2 M SnCl₂.2H₂O in NMP overnight. The resin was filtered and washed with DMF (3×), MeOH (3×), DCM (3×) and MeOH (3×). A small amount of the resin (5 mg) was treated with 20% TFA in DCM (30 min). The cleavage solution was concentrated to give a residue which was analyzed by LC-MS. The expected 3-amino-4-[N-(benzylaminothiocarbonyl)-phenethyl-aminomethyl]benzoic acid was confirmed [>90% purity; retention time, 3.14 min; MS (ES) m/e (relative intensity): 419 (M+H⁺, 100)].

### Example XII: 4-(2-aminobenzalamino)Phenol Wang Resin

To 4-aminophenol Wang resin (1 g, 0.6 mmol) were added 10 mL of THF, 1 M 2-nitrobenzyl bromide in THF (2 mL) and 1 M DIEA in THF (2 mL). The resulting slurry was shaken at room temperature for 12 h. The resin was the filtered and washed with DMF (3×), MeOH (3×), DCM (3×) and MeOH (3×). After drying in air for 1 h, a small amount of the obtained resin was subjected to the TFA cleavage (20% TFA in DCM, 30 min). LC-MS analysis confirmed the desired 4-(2-nitrobenzylamino)phenol [retention time: 2.55 min, MS (ES) m/e: 245(M+H⁺, 100)].

To the resin obtained above was then treated 15 mL of 2 M SnCl₂.2H₂O in NMP overnight. The resin was filtered and washed with DMF (3×), MeOH (3×), DCM (3×) and MeOH (3×). A small amount of the resin (5 mg) was treated with 20% TFA in DCM (30 min). The cleavage solution was concentrated to give a residue which was analyzed by LC-MS. The expected 4-(2-aminobenzylamino)phenol was confirmed [>80% purity; retention time, 2.44 min; MS (ES) m/e (relative intensity): 196 (30), 106 (100)].

### Example XIII: 3-(2-aminobenzalamino)Phenol Wang Resin

The same procedure for the preparation of Example XII was followed. 3-Aminophenol Wang resin was used instead of To 4-aminophenol Wang resin. LC-MS analysis of a sample cleaved from 5 mg of the resin (20% TFA in DCM, 30 min) confirmed the desired 3-(2-aminobenzylamino)phenol [>90% purity; retention time, 2.53 min; MS (ES) m/e (relative intensity): 215 (M+H⁺, 20), 106 (100)].

### Example XIV: 2-Benzamidobenzylamine Carbamate Wang Resin

To 4-Nitrophenylcarbonate Wang resin (200 mg, 1.1 mmol/g) were added 2 mL of 1 M solution of 2-aminobenzylamine in NMP and 1 mL of 2 M solution of DIEA in NMP. The suspension was then shaken at room temperature for 12 h. The resin was the filtered and washed with DMF (3×), MeOH (3×), DCM (3×) and MeOH (3×). After drying in vacuo, the resin was mixed 3 mL of a mixture of pyridine and DCM (1:3). Benzoyl chloride (1.4 mmol) was added. The resulting slurry was shaken at rt for 5 h. The resin was filtered and washed with DMF (3×), MeOH (3×), DCM (3×) and MeOH (3×). A small amount of the resin (5 mg) was treated with 20% TFA in DCM (30 min). The cleavage solution was concentrated to give a residue which was analyzed by LC-MS. The expected 2-benzamidobenzylamine was confirmed [>90% purity; MS (ES) m/e: 226 (M+H⁺, 100)]

### Example XV: 2-Aminobenzvlpropylamine Carbamate Wang Resin

2-Nitrobenzylpropylamine: 2-Nitrobenzyl bromide (1 g, 4.6 mmol) was dissolved in 10 mL of THF. The solution was then slowly added to a mixture of propylamine (3 equiv.) and THF (20 mL). The mixture was stirred at rt for 2 h. Concentration gave a residue to which was added EtOAc. The solid was filtered and rinsed with a minimum amount of EtOAc. The filtrate was concentrated to give the desired 2-nitrobenzylpropylamine in quantitative yield and good purity (retention time, 2.43 min; MS (ES) m/e (relative intensity): 195 (M+H⁺, 40), 136 (100)].

A solution of 1 M freshly prepared 2-nitrobenzylpropylamine in NMP (2 mL) was added to the resin prepared above (200 mg). After the addition of 2 mL of IM DIEA in NMP, the suspension was heated at 60 C for 8 h. After drying in air for 1 h, a small amount of the obtained resin was subjected to the TFA cleavage (20% TFA in DCM, 30 min). LC-MS analysis confirmed the desired coupling of the 2-nitrobenzylpropylamine onto the carbonate resin.

To the resin obtained above was then treated 3 mL of 2 M SnCl₂.2H₂O in NMP overnight. The resin was filtered and washed with DMF (3×), MeOH (3×), DCM (3×) and MeOH (3×). A small amount of the resin (5 mg) was treated with 20% TFA in DCM (30 min). The cleavage solution was concentrated to give a residue which was analyzed by LC-MS. The expected 2-aminobenzylpropylamine was confirmed [>80% purity; retention time, 2.36 min; MS (ES) m/e (relative intensity): 165 (20), 106 (100)].

### Example XVI: N-(2-amino-5-hydroxybenzvl)-phenylalanine Wang Resin

To phenylalanine Wang resin (200 mg, 0.7 mmol/g) were added 2-nitro-5-hydroxybenzaldehyde (334 mg, 2 mmol) and TMOF (2 mL). The suspension was mixed for 30 min. To the mixture were then added a solution of 0.78 M NaBH₃CN in TMOF (2.5 mL, 2 mmol) and 60 μL of HOAc. The slurry continued stirring for 15 min. The resin was filtered and washed as usual. After drying in air for 1 h, a small amount of the obtained resin was subjected to the TFA cleavage (20% TFA in DCM, 30 min). LC-MS analysis confirmed the desired N-(2-nitro-5-hydroxybenzyl)phenylalanine [>98% purity; retention time, 2.81 min; MS (ES) m/e (relative intensity): 317 (M+H⁺, 100)].

To the resin obtained above was then treated 3 mL of 2 M SnCl₂.2H₂O in NMP overnight. The resin was filtered and washed with DMF (3×), MeOH (3×), DCM (3×) and MeOH (3×). A small amount of the resin (5 mg) was treated with 20% TFA in DCM (30 min). The cleavage solution was concentrated to give a residue which was analyzed by LC-MS. The expected N-(2-amino-5-hydroxybenzyl)-phenylalanine was confirmed [>90% purity; retention time, 2.18 min; MS (ES) m/e (relative intensity): 285 (30)].

### Example XVII: 3-{N-Butyric-[1-(Butylaminocarbonyl)-1-(2-amino-5Bromophenyl)Methylamino}-propionic Acid Wang Resin

β-Alanine Wang resin (500 mg, 0.27 mmol) was mixed with 5 mL of 1:1 MeOH/THF. To the suspension was added butyric acid (250 tL, 2.7 mmol), 2-nitro-5-bromobenzaldehyde (0.5 g, 2.7 mmol), a solution of 2 M n-butyl isocyanide in MeOH (1.35 mL, 2.7 mmol) and a solution of 1 M ZnCl₂ in diethyl ether (1.35 mL, 1.35 mmol). The resulting mixture was shaken at rt for 48 h. The resin was filtered and washed DMF (3×), MeOH (3×), DCM (3×) and MeOH (3×). A small amount of the resin (5 mg) was treated with 20% TFA in DCM (30 min). The cleavage solution was concentrated to give a residue which was analyzed by LC-MS. The expected Ugi product was confirmed [>95% purity; MS (ES) m/e (relative intensity): 473 (M+H+, 100)].

To the resin obtained above (200 mg) was then treated 3 mL of 2 M SnCl₂.2H₂O in NMP overnight. The resin was filtered and washed with DMF (3×), MeOH (3×), DCM (3×) and MeOH (3×). A small amount of the resin (5 mg) was treated with 20% TFA in DCM (30 min). The cleavage solution was concentrated to give a residue which was analyzed by LC-MS [>95% purity; retention time, 2.83 min; MS (ES) m/e (relative intensity): 443 (M+H⁺, 90); 273 (100)].

### Example XVIII: (N-Fmoc-3-amino)-3-(2-aminophenyl)-propionic Acid Rink Resin

To the deprotected Rink resin (215 mg, 0.7 mmol/g) was added N-Fmoc-3-amino)-3-(2-nitrophenyl)propionic acid (215 g, 0.5 mmol) and 1 mL of DMF. A solution of 1 M DIC in DCM (0.5 mL, 0.5 mmol) was then added. The resulting slurry was shaken at room temperature for 4 h. The resin was filtered and washed with DMF (3×), MeOH (3×) and DCM (3×), MeOH (2×). After drying in air, a small amount of the N-Fmoc-3-amino-3-(2-nitrophenyl)propionic acid Rink resin was subjected to the Kaiser test which indicated negative. LC-MS analysis of a sample cleaved from 10 mg of the resin (20% TFA in DCM, 20 min) confirmed the desired N-Fmoc-3-amino-3-(2-nitrophenyl)propionamide [>98% purity, retention time: 3.33 min, MS (ES) m/e: 433, M+H⁺].

The nitro resin was then treated with 3 mL of 2 M SnCl₂.2H₂O in NMP overnight. The resin was filtered and washed with DMF (3×), MeOH (3×), DCM (3×) and MeOH (3×). A small amount of the resin (5 mg) was treated with 20% TFA in DCM (20 min). The cleavage solution was concentrated to give a residue which was analyzed by LC-MS. The expected N-Fmoc-3-amino-3-(2-aminophenyl)propionamide was confirmed (>95% purity; retention time, 0.25 min; MS (ES) m/e: 385 (M⁺-NH3, 100).

### Example XIX: N-Butvric-1-(Cyclohexvlaminocarbonyl)-1-(2-amino-5-fluorophenyl)Methylamine Rink Resin

The de-protected Rink resin (500 mg, 0.35 mmol) was mixed with 5 mL of 1:1 MeOH/THF. To the suspension was added butyric acid (319 [tL, 3.5 mmol), 2-nitro-5-fluorobenzaldehyde (591 mg, 3.5 mmol), a solution of 2 M cyclohexyl isocyanide in MeOH (1.75 mL, 3.5 mL) and a solution of 1 M ZnCl2 in diethyl ether (1.75 mL, 1.75 mmol). The resulting mixture was shaken at rt for 48 h. The resin was filtered and washed DMF (3×), MeOH (3×), DCM (3×) and MeOH (3×). A small amount of the resin (5 mg) was treated with 20% TFA in DCM (30 min). The cleavage solution was concentrated to give a residue which was analyzed by LC-MS. The expected Ugi product was confirmed [>95% purity; MS (ES) m/e (relative intensity): 366 (M+H⁺, 60)].

To the resin obtained above was then treated 5 mL of 2 M SnCl₂.2H₂O in NMP overnight. The resin was filtered and washed with DMF (3×), MeOH (3×), DCM (3×) and MeOH (3×). A small amount of the resin (5 mg) was treated with 20% TFA in DCM (30 min). The cleavage solution was concentrated to give a residue which was analyzed by LC-MS [>90% purity; retention time, 2.80 min; MS (ES) m/e (relative intensity): 318 (M⁺-18, 100)].

### Example XX: 3-{N-Benzyl[1-(butylaminocarbonyl)-1-l(2-amino-5hydroxyphenyl)Methylaminocarbonyl}-propionic Acid Rink Resin

Succinic acid Rink resin: To de-Fmoc Rink resin (1 g, 0.7 mmol) was added 10 mL of dry THF. DIEA (3 equiv.) and succinic anhydride (350 mg, 5 equiv.) was then added. The resulting suspension was shaken at rt for 12 h. After the addition of 0.1 mL of acetic anhydride and 0.2 mL of pyridine, the slurry continued stirring for another 30 min. The resin was then filtered and washed with DMF (3×), 10% HOAc in DCM (2×), DMF (3×), MeOH (3×), DCM (3×) and MeOH (3×), finally dried in vacuo overnight.

The above resin (300 mg, 0.15 mmol) was then mixed 2 mL of 1:1 MeOH/THF. To the suspension was added benzyl amine (163 [LL, 1.5 mmol), 2-nitro-5-hydroxybenzaldehyde (250 mg, 1.5 mmol) and a solution of 2 M n-butyl isocyanide in MeOH (750 mL, 1.5 mL). The resulting mixture was shaken at rt for 48 h. The resin was filtered and washed DMF (3×), MeOH (3×), DCM (3×) and MeOH (3×). A small amount of the resin (5 mg) was treated with 20% TFA in DCM (30 min). The cleavage solution was concentrated to give a residue which was analyzed by LC-MS. The expected Ugi product was confirmed [>95% purity; retention time, 2.97 min; MS (ES) m/e (relative intensity): 457 (M+H⁺, 60)].

To the resin obtained above was then treated 5 mL of 2 M SnCl₂.2H₂O in NMP overnight. The resin was filtered and washed with DMF (3×), MeOH (3×), DCM (3×) and MeOH (3×). A small amount of the resin (5 mg) was treated with 20% TFA in DCM (30 min). The cleavage solution was concentrated to give a residue which was analyzed by LC-MS [>90% purity; retention time, 2.70 min; MS (ES) m/e (relative intensity): 409 (M⁺-18)].

### Example XXI: 3-(3-hydroxyphenyl)-3,4-dihydroquinazoline

To 3-(2-aminobenzylamino)phenol Wang resin (Example XIII) (100 mg, 0.6 mmol/g) were added 20% TFA in DCM (1.5 mL) and trimethylorthoformate (TMOF) (0.15 mL). The resulting slurry was shaken at rt for 30 min. The resin was filtered and rinsed with 5 mL of DCM. The combined filtrates were concentrated to give a residue which was re-dissolved in 5 mL of acetonitrile. The solvent was then removed on a rotavapor to give the crude product (10 mg, >80% purity). LC-MS analysis: retention time, 2.59 min; MS (ES) m/e (relative intensity): 225 (M+H⁺, 100)].

### Example XXII: 2-Phenyl-3,4-dihydroquinazoline

A mixture of 2-Benzamidobenzylamine carbamate Wang resin (Example XIV) (100 mg, 0.6 mmol/g) and 2 mL of o-xylene was heated at 100 C for 24 h. The resin was filtered and washed with MeOH and DCM. It was then treated with 20% TFA in DCM for 30 min. The resin was filtered and rinsed with 5 mL of DCM. The combined filtrates were concentrated to give a residue which was re-dissolved in 5 mL of acetonitrile. The solvent was then removed on a rotavapor to give the crude product (12 mg, >₆₀% purity). LC-MS analysis: retention time, 3.03 min; MS (ES) m/e (relative intensity): 209 (M+H+, 40)].

### Example XXIII: 7-Carboxylic-2-Phenethyl-3-phenethyl-3,4-dihydroquinazoline

Method A: A mixture of 3-amino-4-(N-(3-phenylpropionic)-phenethylaminomethyl)-benzoic acid Wang resin (Example IX) (50 mg, 0.5 mmol/g) and 1 mL of o-xylene was heated at 100 C for 24 h. The resin was filtered and washed with MeOH and DCM. It was then treated with 20% TFA in DCM for 30 min. The resin was filtered and rinsed with 5 mL of DCM. The combined filtrates were concentrated to give a residue which was re-dissolved in 5 mL of acetonitrile. The solvent was then removed on a rotavapor to give the crude product (10.4 mg, >90% purity). LC-MS analysis: retention time, 2.98 min; MS (ES) m/e (relative intensity): 385(M+H⁺, 100)].

Method B: To 3-amino-4-(phenethylaminomethyl)-benzoic acid Wang resin (Example III) (50 mg, 0.6 mmol) were added DMF (200 μL), 1 M benzaldehyde in DMF (200 tL) and 1 M DDQ in DMF (200 tL). The resulting suspension was shaken at rt for 6 h. The resin was filtered and washed with DMF (3×), 0.5 M DIEA in DMF (2×), MeOH (6×), DCM (6×) MeOH (3×). It was then treated with 20% TFA in DCM for 30 min. The resin was filtered and rinsed with 5 mL of DCM. The combined filtrates were concentrated to give a residue which was re-dissolved in 5 mL of acetonitrile. The solvent was then removed on a rotavapor to give the crude product (12 mg, >90% purity). LC-MS analysis confirmed the desired product.

### Example XXIV: 6-Bromo-2-propyl-3-(2-carboxyethyl)-4-butylaminocarbonyl-3 ,4-dihydroquinazoline

A mixture of 3-{N-Butyric-[1-(butylaminocarbonyl)-1-(2-amino-5-bromophenyl)methylamino}-propionic acid Wang resin (Example XVII) (100 mg, 0.6 mmol/g) and 2 mL of o-xylene was heated at 100 C for 24 h. The resin was filtered and washed with MeOH and DCM. The resin was then treated with 20% TFA in DCM for 30 min. The resin was filtered and rinsed with 5 mL of DCM. The combined filtrates were concentrated to give a residue which was re-dissolved in 5 mL of acetonitrile. The solvent was then removed on a rotavapor to give the crude product (21 mg, >80% purity). LC-MS analysis: MS (ES) m/e (relative intensity): 425 (M+H⁺, 100)].

### Example XXV: ₆-Fluoro-2-propyl-4-cyclohexnlaminocarbonyl-3,4dihydroquinazoline

To N-Butyric-1-(cyclohexylaminocarbonyl)-1-(2-amino-5-fluoro-phenyl)Methylamine Rink resin (Example XIX) (50 mg, 0.6 mmol) was added 20% TFA in DCM (1.0 mL). The resulting slurry was shaken at rt for 30 min. The resin was filtered and rinsed with 5 mL of DCM. The combined filtrates were concentrated to give a residue which was re-dissolved in 5 mL of acetonitrile. The solvent was then removed on a rotavapor to give the crude product (9 mg, >90% purity). LC-MS analysis: retention time, 2.80 min; MS (ES) m/e (relative intensity): 318 (M+H⁺, 100)].

### Example XXVI: 6-Fluoro-2-propyl-4-cyclohexvlaminocarbonyl-dihydroquinazoline

A mixture of N-Butyric-1-(cyclohexylaminocarbonyl)-1-(2-amino-5-fluoro-phenyl)methylamine Rink resin (Example XIX) (50 mg, 0.6 mmol) and acetic acid (1.5 mL) was heated at 100 C for 48 h. After cooling to rt, the resin was filtered and rinsed with 5 mL of THF. The combined filtrates were concentrated to give the crude product (6 mg, >90% purity). LC-MS analysis: retention time, 3.97 min; MS (ES) m/e (relative intensity): 316 (M+H⁺, 100)].

### Example XXVII: 6-Hydroxy-2- (2-aminocarbonylethyl)-3-benzyl-4-butylaminocarbonyl-3,4-dihydroquinazoline

To 3-{N-Benzyl[1-(butylaminocarbonyl)-1-(2-amino-5-hydroxyphenyl)methylaminocarbonyl}-propionic acid Rink resin (Example XX) (100 mg, 0.55 mmol) was added 20% TFA in DCM (1.0 mL). The resulting slurry was shaken at rt for 30 min. The resin was filtered and rinsed with 5 mL of DCM. The combined filtrates were concentrated to give a residue which was re-dissolved in 5 mL of acetonitrile. The solvent was then removed on a rotavapor to give the crude product (18 mg, >90% purity). LC-MS analysis: retention time, 2.70 min; MS (ES) m/e (relative intensity): 409 (M+H⁺, 100)].

### Example XXVIII: 7-Carboxylic-2-(1-amino-2-phenylethyl)-3-[3- (2-oxopyrrolidino)Propyl]-3,4-dihydroquinazoline

To 3-amino-4-(N-3-(2-oxopyrrolidinyl)propyl-N-(Fmoc-phenylalanine)aminomethyl)benzoic acid Wang resin (Example VIV) (100 mg, 0.5 mmol/g) was added 2 mL of 20% piperidine in DMF. The slurry was mixed for 30 min. The resin was filtered and washed as usual. The dried resin was then mixed with 3 mL of o-xylene. The suspension was heated at 100C for 24 h. The resin was filtered and washed with MeOH and DCM. After drying in air for 1 h, the resin was treated with 20% TFA in DCM for 30 min. the cleavage solution was processed as usual to give the desired product (25 mg, 85% purity). MS (ES) m/e (relative intensity): 421 (M+H⁺, 40)].

### Example XXIX: 7-Carboxylic-3—phenethyl-3,4-dihydroquinazoline-2-thiol

To 3-amino-4-(phenethylaminomethyl)-benzoic acid Wang resin (Example III) (100 mg, 0.7 mmol/g) was added DEC (1.5 mL) and 1 M DIEA in DCE (0.42 mL, 0.42 mmol) and 1 M thiophosgene in DCE (0.21 mL, 0.21 mmol). The resulting suspension was shaken at rt for 6 h. The resin was filtered and washed with DMF (3×), MeOH (3×), DCM(3×), MeOH (3×). After drying in air for I h, the resin was treated with 20% TFA in DCM for 30 min. the cleavage solution was processed as usual to give the desired product (21 mg, 85% purity). LC-MS analysis: retention time: 3.07 minMS (ES) m/e (relative intensity): 312 (M+H⁺, 100)].

### Example XXX: 7-Carboxylic-2-benzylamino-3-phenethyl-3,4-dihydroquinazoline

A mixture of 3-Amino-4-[N-(benzylaminothiocarbonyl)-phenethylaminomethyllbenzoic Acid Wang Resin (Example XI) (50 mg, 0.5 mmol/g) and o-xylene (1.0 mL) was heated at 100 C for 12 h. The resin was filtered and washed with MeOH and DCM. The resin was then treated with 20% TFA in DCM for 30 min. The resin was filtered and rinsed with 3 mL of DCM. The combined filtrates were concentrated to give a residue which was re-dissolved in 5 mL of acetonitrile. The solvent was then removed on a rotavapor to give the crude product (9 mg, >90% purity). LC-MS analysis: MS (ES) m/e (relative intensity): 386 (M+H⁺, 100)].

### Example XXXI: 8-Carboxylic-2—phenyl-4-phenethyl-1,4-benzodiazepine-3-one

To a mixture of 4-phenethylaminomethyl-3-nitrobenzoic acid Rink resin (100 mg, 0.6 mmol) and 3 mL of DCM were added benzoyl formic acid (60 mg, 0.4 mmol) and DIC (62.5 mL, 0.4 mmol). The resulting slurry was shaken at rt overnight. The resin was filtered and washed as usual. After drying in air for 2 h, the resin was treated with 2 mL of 2 M SnCl₂.2H₂O in NMP overnight. The resin was filtered and washed with DMF (3×), MeOH (3×), DCM (3×) and MeOH (3×). The dried resin was the treated with 20% TFA in DCM for 30 min. The cleavage solution was concentrated to give the desired product (22 mg, >95% purity). LC-MS analysis: retention time, 2.94 min; MS (ES) m/e (relative intensity): 370 (M+H⁺).

### Example XXXII: (S)-8-Carboxylic-3-benzy-1,4-benzodiazepine-2(1H,4H)-one

To 3-amino-4-((S)-1-methoxycarbonyl-2-phenylethylamino methyl)benzoic acid Rink resin (Example VIII) (500 mg, 0.6 mmol) was added a mixture of 4 mL of 1 N NaOH and 4 mL of THF. The slurry was shaken at rt for 12 h. The resin was filtered and washed with 1:1 THF/H₂O (3×), MeOH (3×), 10% HOAc in DCM (2×), DCM (3×), IM DIEA in DCM (1×), MeOH (3×), DCM (3×). The resin was dried in vacuo.

The resin obtained above (200 mg) was mixed with 15 mL of DMF. To the suspension were then added HOBt (122 mg, 0.8 mmol) and DIC (125 mL, 0.8 mmol). The mixture was shaken at rt overnight. The resin was filtered and washed as usual. The LC-MS analysis of a sample cleaved from a small amount of the resin by 20%TFA in DCM confirmed the successful cyclization. LC-MS: retention time, 2.14 min; MS (ES) m/e (relative intensity): 296 (M+H⁺, 50).

### Example XXXIII: (S)-8-Carboxylic-3-benzv-4-benzalaminocarbonyl-1,4-benzodiazepine-2(1H ,4H)-one

To (S)-8-Carboxylic-3-benzy-1,4-benzodiazepine-2(11H,4H)-one (Example XXXII) (50 mg) was added 2 mL of 0.5 M benzyl isocyanate in DCE. The slurry was shaken at rt for 12 h. The resin was filtered and washed with DMF (3×), MeOH (3×), DCM (3×) and DCM (3×). The dried resin was the treated with 20% TFA in DCM for 30 min. The cleavage solution was concentrated to give the desired product (12 mg, >90% purity). LC-MS analysis: retention time, 2.98 min; MS (ES) m/e (relative intensity): 430 (M+H⁺, 100]

### Example XXXIV: (S)-8-Carboxylic-3-benza-4-butyric-1,4-benzodiazepine-2(1,4H)-one

To a mixture of (S)-8-Carboxylic-3-benzy-1,4-benzodiazepine-2(1H,4H)-one (Example XXXII) (74 mg) and 5 mL of THF were added 108 μL of butyric acid (10 equiv.) and 184 tL of DIC (10 equiv.). The slurry was shaken at rt for 6 h. The process was then repeated once. The resin was filtered and washed with DMF (3×), MeOH (3×), DCM (3×) and DCM (3×). The dried resin was the treated with 20% TFA in DCM for 30 min. The cleavage solution was concentrated to give the desired product (15 mg, >90% purity). LC-MS analysis: retention time, 2.59 min; MS (ES) m/e (relative intensity): 366 (M+H⁺, 60).

### Example XXXV: (S)-8-Carboxylic-3-benza-4-(3-phenylpropyl)-1,4-benzodiazepine-2(1H,4H)-one

To a mixture of (S)-8-Carboxylic-3-benzy-1 ,4-benzodiazepine-2(1H,4H)-one (Example XXXII) (97 mg) was mixed with 5 mL of DMF, dihydrocinnamaldehyde (51 mL, 0.388 mmol), acetic acid (50 mL) and NaBH(OAc)³ (80 mg, 0.388 mmol). The suspension was shaken at rt for 12 h. The resin was filtered and washed with DMF (3×), MeOH (3×), DCM (3×) and DCM (3×). The dried resin was the treated with 20% TFA in DCM for 20 min. The cleavage solution was concentrated to give the desired product (15 mg, >80% purity). LC-MS analysis: retention time, 2.59 min; MS (ES) m/e (relative intensity): 414 (M+H⁺, 100).

As will be understood by those skilled in the art, various arrangements which lie within the spirit and scope of the invention other than those described in detail in the specification will occur to those persons skilled in the art. It is therefor to be understood that the invention is to be limited only by the claims appended hereto.

Having described the invention. We claim:

1. A solid support template of the formula; 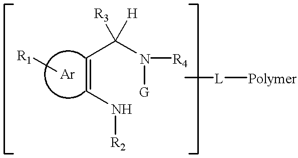
wherein
polymer is a solid support,
L is a multifunctional chemical monomer in which one functional group reacts with the polymer to form a covalent bond and the other functional group reacts with either R₁, R₃, R₄ or G through a plurality of chemical reactions to provide the desired templates for further chemistry. Examples of such monomers include α-amino acids, β-amino acids, 4-aminopiperidine, 3- or 4-hydroxyaniline, piperazine.
R₁ is selected from a group consisting of hydrogen, chloro, fluoro, bromo, iodo, nitro, cyano, substituted alkyl, substituted alkenyl, substituted alkynyl, substituted aryl, substituted heteroaryl, substituted cycloalkyl and substituted alkylcycloalkyl; substututed heterocyclyl, amino, substituted amino, hydroxyl, substituted hydroxyl, substituted sulfhydryl, substituted alkyl sulfonamido, substituted alkyl carboxamido, substituted alkyl ureido, substituted alkyl sulfamido, substituted alkyloxycarboxamido, substituted aryl sulfonamido, substituted aryl carboxamido, substituted aryl ureido, and substituted alkyloxycarboxamido;
R₂ is selected from a group consisting of hydrogen, hydroxy, substituted alkyl, substituted alkenyl, substituted alkynyl, substituted aryl, substituted heteroaryl, substituted cycloalkyl and substituted heterocyclyl;
R₃ is hydrogen, —C(O)NHR₅, substituted alkyl, substituted alkenyl, substituted alkynyl, substituted aryl, substituted heteroaryl, substituted cycloalkyl; substituted heterocyclyl;
G is selected from a group consisting of hydrogen, substituted alkylcarbonyl, substituted arylcarbonyl, substituted arylalkylcarbonyl, substituted alkyloxycarbonyl, substituted N-alkylaminocarbonyl, substituted N,N-dialkylaminocarbonyl, substituted N-arylaminocarbonyl, substituted N,N-diarylaminocarbonyl, substituted N-alkyl-N-arylaminocarbonyl, alkylthiocarbonyl, substituted arylthiocarbonyl, substituted arylalkylthiocarbonyl, substituted N-alkylaminothiocarbonyl, substituted N,N-dialkylaminothiocarbonyl, substituted N-arylaminothiocarbonyl, substituted N,N-diarylaminothiocarbonyl, substituted N-alkyl-N-arylaminothiocarbonyl, substituted alkylsulfonyl, substituted arylsulfonyl; and
R₄ and R₅ are independently selected from a group consisting of hydrogen, substituted alkyl, substituted alkenyl, substituted alkynyl, substituted aryl, substituted heteroaryl, substituted cycloalkyl and substituted heterocyclyl.

2. The solid support of claim 1 of the formula: 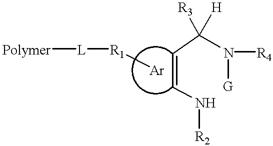
wherein R₁ is a functional or a multifunctional group that contains two attachment points and chemically connects the template to the solid support through said spacer L

3. The solid suport of claim 2 wherein R₁ is selected from the group consisting of substituted alkyl, substituted alkenyl, substituted alkynyl, substituted aryl, substituted heteroaryl, substituted cycloalkyl and substituted alkylcycloalkyl; substututed heterocyclyl; substituted amino, substituted alkyloxy and substituted aryloxy.

4. The solid support of claim 1 of the formula: 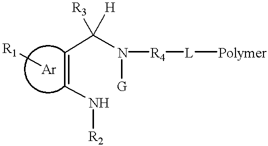
R₄ is a functional or a multifunctional group that contains two attachment points and chemically connects said nitrogen atom of said template to the solid support through linker L.

5. The solid support of claim 4 wherein R₄ is selected from a group consisting of substituted alkyl., substituted alkenyl, substituted alkynyl, substituted aryl, substituted heteroaryl, substituted cycloalkyl and substituted alkylcycloalkyl; substututed heterocyclyl; substituted amino, substituted alkyloxy and substituted aryloxy.

6. The solid support of claim 1 of the formula:

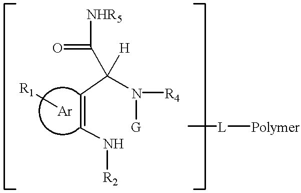

7. A method for the preparation of the aminoarylmeethylamine templates of claim 1 according to the following scheme:

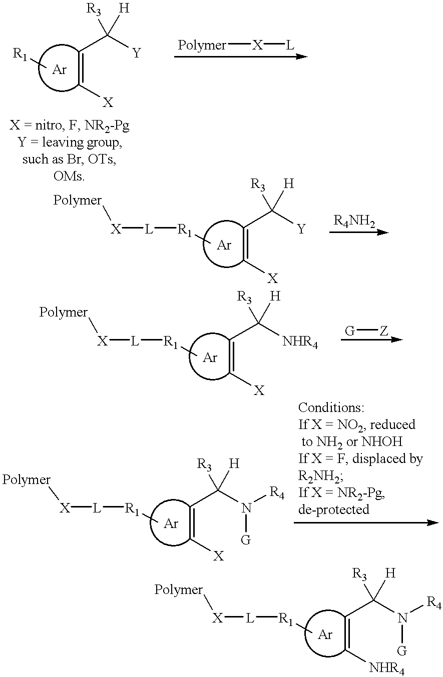

8. A method for the preparation of the aminoarylmeethylamine templates of claim 1 according to the following scheme:

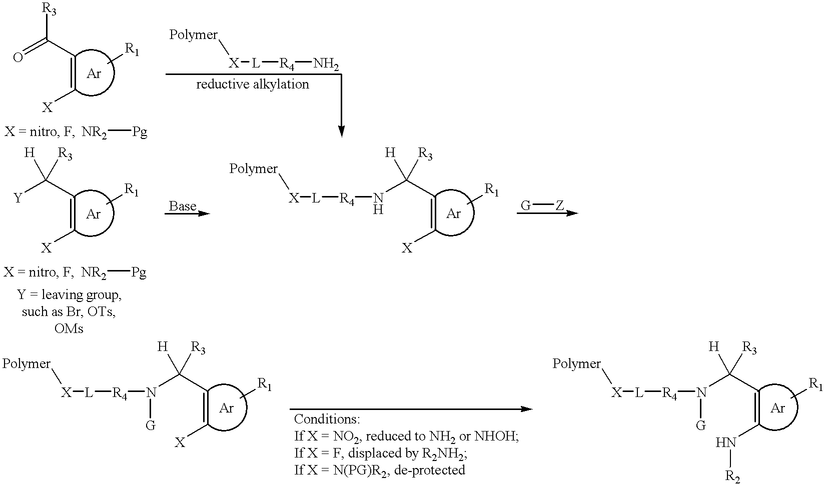

9. A method for the preparation of the aminoarylmeethylamine templates of claim 1 according to the following scheme:

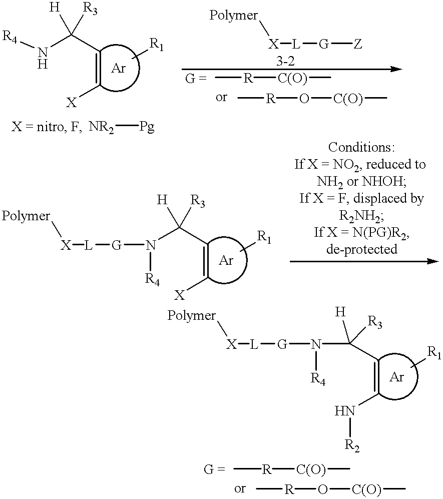

10. A method for the preparation of the aminoarylmethylamine templates of claim 1 according to the following scheme:

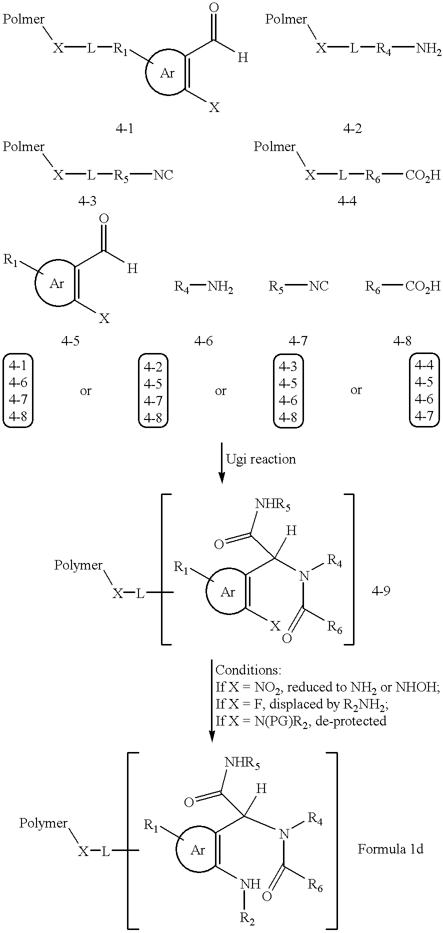

11. A method for the synthesis of heterocyclic scaffolds using the template of claim 1 according to the following:

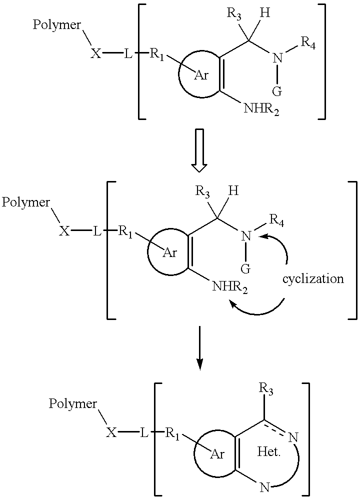

12. A method for the synthesis of scaffolds selected from the group consisting of 3,4-dihydroquinazolines, quinazolines and tetrahydroquinazolines using the template of claim 1 according to the following:

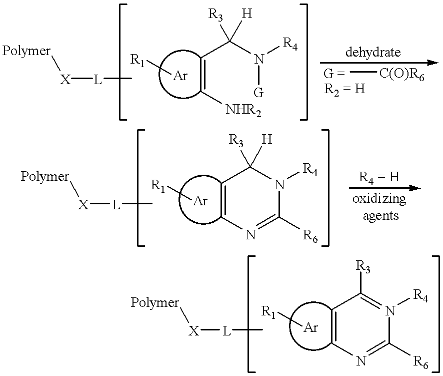

13. A method for the synthesis of scaffolds selected from the group consisting of 3,4-dihydroquinazolines, quinazolines and tetrahydroquinazolines using the template of claim 1 according to the following:

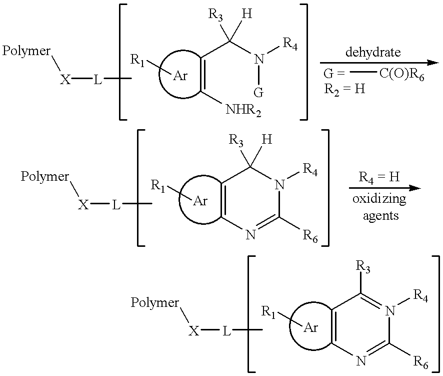

14. A method for the synthesis of scaffolds selected from the group consisting of 2-amino-3,4-dihydroquinazolines and 2-aminoquinazolines using the template of claim 1 according to the following:

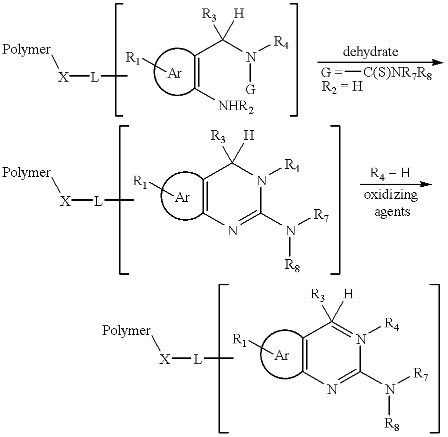

15. A method for the synthesis of a 1,4-benzodiazepine scaffold using the template of claim 1 according to the following:

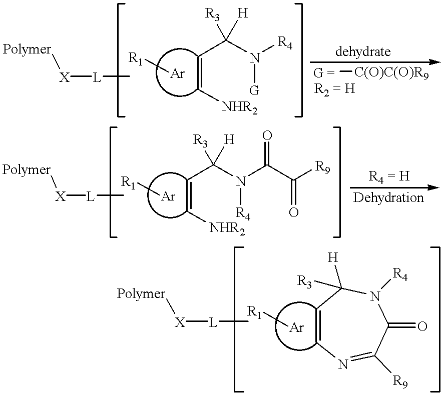

16. A method for the synthesis of a 1,4-benzodiazepine-2-one scaffold using the template of claim 1 according to the following:

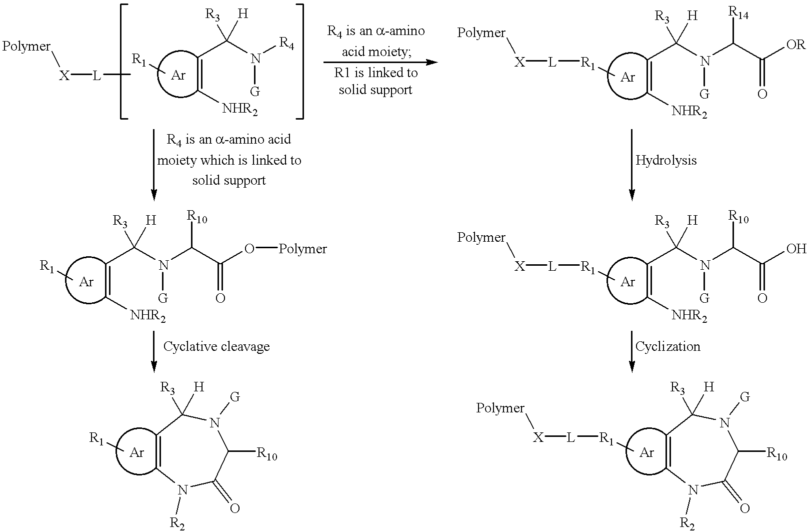

17. A method for the synthesis of scaffolds selected from the group consisting of 3,4-dihydro-2-quinazolinone, 3,4-dihydroquinazoline-2-thione, 2-thioalkyl-3,4-dihydroquinazolines and 2-thioalkyl quinazolines using the template of claim 1 according to the following: [chemical structure]
